(19) United States
(12) Patent Application Publication
(10) Pub. No.: US 2009/0208121 A1
(43) Pub. Date: Aug. 20, 2009

(54) INFORMATION TRANSFER APPARATUS, INFORMATION RECEIVING APPARATUS AND COMPUTER PROGRAM

(75) Inventors: Mitsue Fujinuki, Tokyo (JP); Shogo Yamaguchi, Kanagawa-ken (JP); Shinya Murai, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Minato-ku, Tokyo (JP)

(21) Appl. No.: 12/279,997

(22) PCT Filed: Sep. 21, 2006
(86) PCT No.: PCT/JP2006/319217

§ 371 Date: Aug. 20, 2008

(30) Foreign Application Priority Data
Mar. 10, 2006 (JP) 2006-066640

(51) Int. Cl. G06K 9/36

(52) U.S. Cl. 382/233

(57) ABSTRACT

An information transfer apparatus includes a first image holding unit configured to hold image information of a first region updated in a display screen, a data compressing unit configured to perform compression processing of the image information of the first region outputted from an image acquiring unit, a second image holding unit configured to hold the image information of the first region compressed by the data compressing unit, a region determining unit configured to determine a second region to be a transfer object of a compression error caused by the data compressing unit among the first region, based on output of the image acquiring unit, a data expanding unit configured to extract and expand image information of the second region of the image information held by the second image holding unit, an error calculating unit configured to generate error image information including a compression error based on the image information of the second region in the image information held by the first data holding unit and the image information expanded by the data expanding unit.

### CROSS-REFERENCE TO RELATED APPLICATIONS

This application is based upon and claims the benefit of priority from the prior Japanese Patent Application No. 2006-066640, filed on Mar. 10, 2006; the entire contents of which are incorporated herein by reference.

### BACKGROUND

1. Field of the Invention

The present invention relates to an image transfer apparatus, an image receiving apparatus and a computer program which are capable of transferring or displaying a screen display of a PC, PDA or the like to or on a display screen of another PC or a projector via a network in real time.

2. Description of the Related Art

With a wide spread use of note book type PCs and projectors in recent years, a presentation method in which a PC and a projector are connected by a cable, the screen display of the PC is projected by being enlarged onto the projector, and thereby presentation materials are provided is generally adopted. Since reduction in cost and size of projectors is advanced, this presentation method is more and more utilized for presenting materials and sharing minutes of meetings not only in formal presentation but also in ordinary meetings.

However, a projector tends to be subjected to the constraint of an installation place due to its characteristic of projecting an article on a screen or the like. Therefore, in order to use a projector, a PC has to be disposed near the projector. When a plurality of persons alternately make presentations, each of them needs to carry a PC to a place near the projector and change the PC each time alternation occurs, or preliminary preparation of collectively storing data in one PC in advance or the like is needed.

In order to reduce such labor and preliminary preparation, a system which connects a PC and a projector by wireless transmission means such as a wireless LAN of the IEEE802.11b standards, and Bluetooth (registered trademark) is developed. Connection with the wireless transmission means makes it unnecessary for a person who makes a presentation to carry his or her own PC near to the projector, and makes it possible to dispose the PC at any place in a room. When a plurality of persons alternately make presentations, the operation of changing connection of the PC of the person who makes a presentation can be easily performed. Further, it is possible to easily project the same projected content to a plurality of projectors at the same time.

When the screen display data of a PC is transferred via a network such as radio, an available transmission band is generally limited unlike the case where cable connection is made by an exclusive cable such as an RGB cable, and therefore, compression of image data is required. In the case of transfer of the screen display of a PC, data to be transferred is not known in advance, and a large screen size of XGA (1024×768) size or more is used. When use with an optional PC is considered, it is difficult to prepare a special hardware for encoding, and therefore, a method of transferring the image date in the screen display region where change takes place is transferred as continuous data of a static image is generally used.

As a method for compressing a static image, for example, a lossless compression without a compressive strain utilizing zlib or the like (disclosed in, for example, zlib Home Site, <URL:http://www.zlib.net/>), and a lossy compression with a compressive strain such as JPEG (disclosed in, for example, official JPEG homepage, <URL:http://www.jpeg.org/>) are known. Conventionally, either one of them has been used for static image transmission between a PC and a projector. In the case of using the lossless compression method, when decoding at the receiver side, the original image is literally obtained as it is, but there is the disadvantages of requiring time for compression of an image with many gradations or the like, requiring time for transfer because the data size after compression is large, and the like. On the other hand, in the case of using the lossy compression method, compression can be made in stable compression time irrespective of the content of an image, and data size after compression can be made relatively small, but there arises the problem that after expansion processing, the same image as the original image cannot be obtained, and noise occurs.

Thus, by the method of transferring by using the lossy compression method at first and then transferring the generating compression error later by using lossless processing, repeatability of quick screen update and high image quality are conventionally realized effectively (see JP-A 2005-217827 (KOKAI)). In this conventional method, an image is completely restored by using an expansion method corresponding to a compression method, and a compression error is obtained. Here, in the JPEG method that is a lossy compression method performs compression processing by connecting a plurality of coding processings, and individual coding processings can be classified into lossless and lossy. Accordingly, the cause processing which becomes lossy as a result of encoding is identified, and therefore, only the processing which is lossy has to be originally acquired as the error generating processing. Namely, the conventional method includes useless processing.

The method for acquiring the region before and after the coding processing which is lossy as a difference is used in motion picture compression. However, the target region in which the difference is acquired is not specially determined, and therefore, the difference in the region where the compression error is not generated is obtained as error generating processing as a result. Accordingly, this method also includes useless processing.

Dequantization and inverse DCT (Discrete Cosine Transform) processing included in expansion processing require complicated calculation, and therefore, processing load becomes high. Namely, in the conventional method, as a result of including useless processing, there is the problem that processing load becomes higher than necessary.

Further, since in the compression error acquiring method in the above described static image, the difference is acquired between the images, the difference can be acquired in only the specific region where the screen update occurs, but as for the difference acquisition of the lossy coding processing in a moving image, the above described lossy coding processing is performed in the unit of 8 by 8 dots, and therefore, the difference acquisition region cannot be limited to an optional region. Therefore, there is also the problem that by simply combining both techniques, acquisition of difference in the specific region and reduction in processing load cannot be realized.

### BRIEF SUMMARY OF THE INVENTION

An information transfer apparatus according to one aspect of the present invention includes an image acquiring unit configured to output image information of a first region updated in a display screen, a first image holding unit configured to hold the image information of the first region outputted from the image acquiring unit, a data compressing unit configured to perform compression processing of the image information of the first region outputted from the image acquiring unit, a second image holding unit configured to hold the image information of the first region compressed by the data compressing unit, a region determining unit configured to determine a second region to be a transfer object of a compression error caused by the data compressing unit among the first region, based on output of the image acquiring unit, a data expanding unit configured to extract and expand image information of the second region among the image information held by the second image holding unit, an error calculating unit configured to generate error image information including a compression error based on the image information of the second region among the image information held by the first data holding unit, and the image information expanded by the data expanding unit, and a transfer unit configured to transfer the image information subjected to the compression processing and the generated error image information to an outside.

An information transfer apparatus of another aspect of the present invention includes an image acquiring unit configured to output image information of a first region updated in a display screen, an image holding unit configured to hold the image information of the first region outputted from the image acquiring unit, a data compressing unit configured to perform compression processing of inputted image information and output it, a region determining unit configured to determine a second region to be a transfer object of a compression error caused by the data compressing unit among the first region, based on output of the image acquiring unit, an image extracting unit configured to extract and output image information of the second region among the image information held by the first image holding unit, a data expanding unit configured to expand the image information of the second region which is outputted from the image extracting unit and compressed by the data compressing unit, an error calculating unit configured to generate error image information including a compression error based on the image information of the second region which is outputted from the image extracting unit, and the image information expanded by the data expanding unit, and a transfer unit configured to transfer the image information subjected to the compression processing and the generated error image information to an outside. An information transfer apparatus of another aspect of the present invention includes an image acquiring unit configured to output image information of a first region updated in a display screen, an image holding unit configured to hold the image information of the first region which is acquired, a first data compressing unit configured to compress the image information of the first region which is acquired, a region determining unit configured to determine a second region to be a transfer object of a compression error caused by said data compressing unit among the first region, based on output of said image acquiring unit, a second data compressing unit configured to compress image information of the determined second region among the image information held by said image holding unit, an expanding unit configured to expand the image information of the second region which is compressed by said second data compressing unit, an error calculating unit configured to generate error image information including the compression error based on the image information of the second region among the image information held by said data holding unit, and the image information expanded by said data expanding unit, and a transfer unit configured to transfer updated image information including the image information after compression obtained from said first data compressing unit, and the error image information generated by said error calculating unit to an outside.

An information receiving apparatus according to another aspect of the present invention includes a receiving unit configured to receive compressed image information of a first region in a display screen, and error image information of a second region including an error caused by the compression in the first region, a data expanding unit configured to expand the received image information, an expanded image holding unit configured to hold the expanded image information, a region determining unit configured to determine the second region in which the error should be corrected of the image information held in the expanded image holding unit, based on the received error image information, an error correcting unit configured to synthesize image information corresponding to the second region among the image information held by the expanded image holding unit, and the error image information, and generate an error correction image, and an image display unit configured to display an image of the expanded image information and the generated error correction image on a screen.

A computer program according to another aspect of the present invention causes a computer to function as an information transfer apparatus characterized by including an image acquiring unit configured to output image information of a first region updated in a display screen, a first image holding unit configured to hold the image information of the first region outputted from the image acquiring unit, a data compressing unit configured to perform compression processing of the image information of the first region outputted from the image acquiring unit, a second image holding unit configured to hold the image information of the first region compressed by the data compressing unit, a region determining unit configured to determine a second region to be a transfer object of a compression error caused by the data compressing unit among the first region, based on output of the image acquiring unit, a data expanding unit configured to extract and expand image information of the second region among the image information held by the second image holding unit, an error calculating unit configured to generate error image information including a compression error based on the image information of the second region among the image information held by the first data holding unit, and the image information expanded by the data expanding unit, and a transfer unit configured to transfer the image information subjected to the compression processing and the generated error image information to an outside.

A computer program according to another aspect of the present invention causes a computer to function as an information transfer apparatus characterized by including an image acquiring unit configured to output image information of a first region updated in a display screen, an image holding unit configured to hold the image information of the first region outputted from the image acquiring unit, a data compressing unit configured to perform compression processing of inputted image information and output it, a region determining unit configured to determine a second region to be a transfer object of a compression error caused by the data compressing unit among the first region, based on output of the image acquiring unit, an image extracting unit configured to extract and output image information of the second region among the image information held by the image holding unit, a data expanding unit configured to expand the image information of the second region which is outputted from the image extracting unit and compressed by the data compressing unit, an error calculating unit configured to generate error image information including the compression error based on the image information of the second region which is outputted from the image extracting unit, and the image information expanded by the data expanding unit, and a transfer unit configured to transfer the image information subjected to the compression processing and the generated error image information to an outside.

### BRIEF DESCRIPTION OF THE DRAWINGS

FIG. 1 is a view showing the outline of a projector system of one embodiment.

FIG. 2 is a view showing the outline of a projector system of one embodiment.

FIG. 3 is a block diagram showing an information transfer apparatus of the first embodiment.

FIG. 4 is a flow chart showing the operation of an information transfer apparatus 1 of the embodiment.

FIG. 5 is a block diagram showing an image compressing unit in the information transfer apparatus of the embodiment.

FIG. 6 is a view showing an outline of a frame buffer included in the image compressing unit in the information transfer apparatus of the embodiment.

FIG. 7 is a flow chart showing the operation of an image compressing unit 114 in the information transfer apparatus 1 of the embodiment.

FIG. 8 is a block diagram showing an image compressing unit in an information transfer apparatus of the second embodiment.

FIG. 9 is a flow chart showing the operation of an image compressing unit 214 in the information transfer apparatus of the embodiment.

FIG. 10 is a block diagram showing an image compressing unit in an information transfer apparatus of the third embodiment.

FIG. 11 is a flow chart showing the operation of an image compressing unit 314 in the information transfer apparatus of the embodiment.

FIG. 12 is a block diagram showing an image compressing unit in an image transfer apparatus of the fourth embodiment.

FIG. 13 is a flow chart showing the operation of an image compressing unit 414 in the information transfer apparatus of the embodiment.

FIG. 14 is a block diagram showing an image compressing unit in an information transfer apparatus of the fifth embodiment.

FIG. 15 is a flow chart showing the operation of an image compressing unit 514 in the information transfer apparatus of the embodiment.

FIG. 16 is a block diagram showing an image compressing unit in an information transfer apparatus of the sixth embodiment.

FIG. 17 is a flow chart showing the operation of an image compressing unit 614 in the information transfer apparatus of the embodiment.

FIG. 18 is a block diagram showing an information receiving apparatus of the seventh embodiment.

FIG. 19 is a flow chart showing the operation of the information receiving apparatus according to the embodiment.

FIG. 20 is a block diagram showing a received data processing unit in an information receiving apparatus of the eighth embodiment.

FIG. 21 is a flow chart showing the operation of the information receiving apparatus according to the embodiment.

FIG. 22 is a block diagram showing a received data processing unit in an information receiving apparatus of the ninth embodiment.

FIG. 23 is a flow chart showing the operation of the information receiving apparatus according to the embodiment.

### DETAILED DESCRIPTION

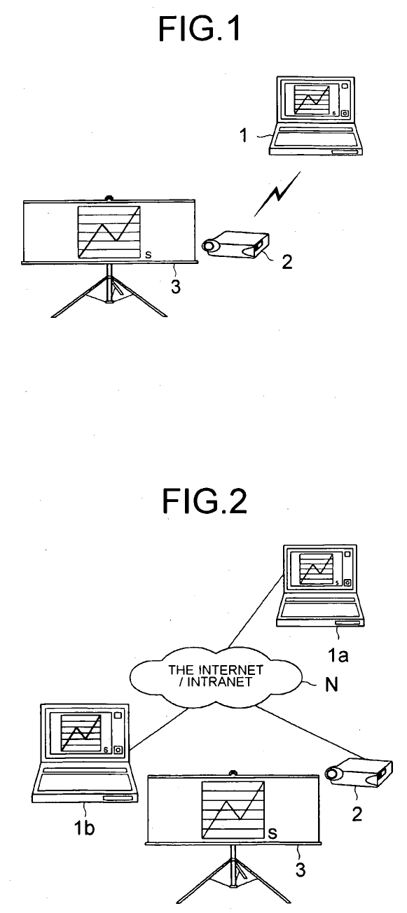

One embodiment of the present invention will now be described in detail with reference to the drawings. AS shown in FIG. 1, a projector system of this embodiment has an information transfer apparatus 1, an information receiving apparatus 2 and a screen 3.

The information transfer apparatus 1 is information generating/transmitting means which generates image information for presentation, and transfers the image information to the information receiving apparatus 2. The information transfer apparatus 1 is realized by a personal computer (PC) or the like, and has a function of transferring updated image information among images in the image information, error information of an error due to compression transfer and the like.

The information receiving apparatus 2 is a projector which is connected to the information transfer apparatus 1 by a line such as radio, and projects the image information transferred from the information transfer apparatus 1 onto the screen 3. The information receiving apparatus 2 generates a concrete screen display based on the image information transferred from the information transfer apparatus 1, and projects it onto the screen 3 to display it. The information receiving apparatus 2 generates a plurality of display images with noise suppressed based on the updated image information, error information and the like which are transferred from the information transfer apparatus 1. In the example shown in FIG. 1, the same screen display as the screen display of the information transfer apparatus 1 operated by a user is displayed on the screen 3 by the information receiving apparatus 2. As the line between the information transfer apparatus 1 and the information receiving apparatus 2, a radio line such as, for example, IEEE802.11b, and the like can be used.

FIG. 2 shows another example of the projector system. In the example shown in FIG. 2, the information transfer apparatuses 1a and 1b and the information receiving apparatus 2 are connected by using a network N such as the Internet and an intranet instead of a radio line. In this example, the information transfer apparatuses which transfer the display information of the screens do not need to exist close to each other, and even if they exist in remote places away from each other, they can transfer display information of the screens to each other.

In the projector system of this embodiment, the information transfer apparatus 1 which generates display information and transfers it, and the information receiving apparatus 2 which receives the display information and projects it onto the projector 3 do not have to be disposed close to each other. Namely, even when the place where presentation is performed (the place where the screen 3 and the information receiving apparatus 2 are installed), and the place where information is generated and stored (the place where the information transfer apparatus 1 is installed) are away from each other, presentation can be realized.

In this example, the information receiving apparatus 2 projects the display image onto the screen 3, but the system is not limited to this. Namely, instead of projecting the information onto the screen 3, the information receiving apparatus 2 may directly display the display image on display means included in the information receiving apparatus 2.

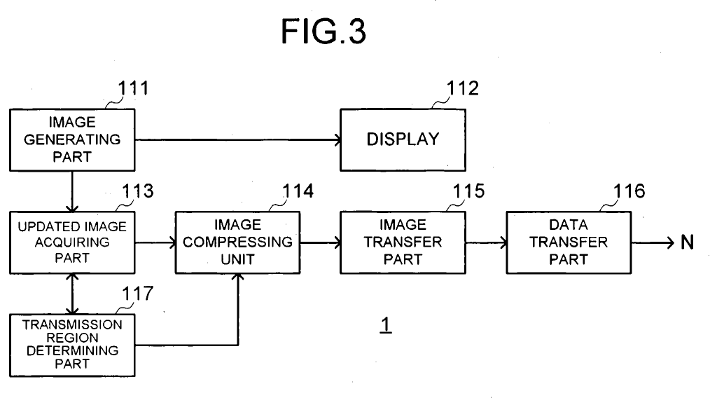

Subsequently, the information transfer apparatus according to the first embodiment of the present invention will be described in detail with reference to FIG. 3. As shown in FIG. 3, the information transfer apparatus 1 of the embodiment includes an image generating part 111, a display 112, an updated image acquiring part 113, an image compressing unit 114, an image transfer part 115, a data transfer part 116, and a transmission region determining part 117.

The image generating part 111 is display image generating means which generates image information (display information) to be displayed on the display 112. The image generating part 111 generally includes a frame buffer (not shown) in a size corresponding to the resolution of the screen to store the newest image to be displayed. The image generating unit 111 generates the image information of a display image by the cooperative operation of an installed application and OS, and a display driver, and writes the generated image information into the frame buffer. The image generating part 111 is realized by the application or the like which generates image information, such as a presentation material creating application, a word processor application, and a spreadsheet application, for example. After writing the generated image information into the frame buffer, the image generating unit 111 transfers the content to the display 112.

The display 112 is image display means which displays a corresponding image based on the image information generated by the image generating part 111. As the display 112, a display device generally used for a PC or the like, such as an LCD display and a CRT display can be used.

The updated image acquiring part 113 is updated image information acquiring means which acquires updated image information including image data at a time of updating the display image, and data of its updated position and the like for example, from the image generating part 111. The updated image acquiring part 113 has a function of extracting the updated image information (image information of the first region) as the updated image information, based on the image information generated and written in the frame buffer by the image generating part 111. For example, the updated image acquiring part 113 receives all updated information (all data of the image data) which is generated for updating the image from the image generating part 111, and directly utilizes it as the updated image information. The updated image acquiring part 113 may acquire the newest image information from the image generating part 111 at fixed intervals, and compare the acquired newest image information and the image information acquired at the previous time, whereby it may extract the updated portion as the updated image information. Further, the updated image acquiring part 113 may monitor which portion is updated by hooking an event of a drawing system such as screen update and the like utilized in the system, and may acquire only the image of the obtained updated portion from the frame buffer as the updated image information.

The updated image acquiring unit 113 transfers the acquired updated image information to the image compressing unit 114. As a result, the image information, which is transferred to the image compressing unit 114 from the updated image acquiring unit 113, becomes the data in which static image data continue. Update of the image information may be performed in the unit of the entire screen, may be performed in the unit of a specific portion of the screen (for example, unit of window, unit of all or a part in the window, and the like), or may be performed in the unit of an optional portion of the screen.

The image compressing unit 114 is data compressing means which performs compression processing of the image data, among the updated image information and error information transferred from the updated image acquiring part 113 and the transmission region determining part 117 which will be described later. The image compressing unit 114 is realized by data compressing means using, for example, a JPEG method which is used the most generally in compression of static images, and the like. In the information transfer apparatus 1 of this embodiment, image information is transferred via the network N with the limited band, and therefore, the lossy compression excellent in compression efficiency is used. The image compressing unit 114 transfers the image data after compression as well as the updated position information of the image to the image transfer part 115.

The image transfer part 115 is data transmitting means which transfers the updated image information or the image information in which the compression error information is compressed to the image receiving apparatus 2. The image transfer part 115 has the function of instructing the data transfer part 116 to transfer the updated image information including the updated position and the compressed image data. The image transfer part 115 also has the function of adding information of the image data size before and after compression, and the like to the image information when required for restoration and display of the image information in the information receiving apparatus 2.

When transferring the error information, the image transfer part 115 instructs the data transfer part 116 to transfer the error information so as to make it discriminable from updated image information so that the compression error can be correctly reflected in the display image in the information receiving apparatus 2. More specifically, the image transfer part 115 transfers updated image information and error information by adding flag information indicating whether they are the updated image information or the error information to them.

The data transfer part 116 is a network interface which transmits image information to the information receiving apparatus 2. As the data transfer part 116, a communication interface which corresponds to the network N, such as Ethernet (registered trade name) and a modem can be used.

The transmission region determining part 117 is compression error transmission region determining means which makes a decision as to whether to transmit a compression error or not based on the updated image information of the screen, and determines an image region (second region) to which the compression error is transmitted. The transmission region determining part 117 determines the error information to be transmitted, for example, when an image in a certain region is updated, and thereafter, it is not updated for a specified time. Namely, the transmission region determining part 117 does not transmit a compression error for the image information of the screen which is displayed for only a short time, but transmits the compression error only when the display is continued for a specified time or more and the compression error becomes conspicuous. The transmission region determining part 117 does not transmit a compression error when the image of the region is updated. This is because updating of the image makes transmission of the error compression meaningless. In this case, the transmission region determining part 117 notifies the image compression part 114 to transmit the compression error of the region where update is not performed for a specified time. The method of determining the region to which the transmission region determining part 117 transmits a compression error is not limited to this, and various other methods can be used.

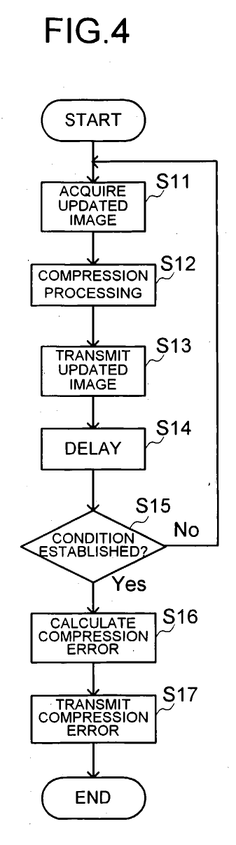

Next, with reference to FIG. 4, an operation of the information transfer apparatus 1 of this embodiment will be described. When the image generating part 111 updates image information of the screen display, the updated image acquiring part 113 acquires the updated image information (step 11. described as “S11” hereinafter). When acquiring the updated image information, the updated image acquiring unit 113 transfers the acquired updated image information to the image compressing unit 114.

When the updated image information is transferred, the image compressing unit 114 performs compression processing of the updated image information by a predetermined lossy compression method (S12).

The updated image information subjected to compression processing is transferred to the image transfer part 115, and transmitted to the network N via the data transfer part 116 (S13).

The transmission region determining part 117 monitors the updated image information acquired by the updated image acquiring part 113 and waits until a specified time elapses (S14). The transmission region determining part 117 determines whether a predetermined condition (for example, the updated region relating to the updated image information which is transferred is not updated yet after the specified time elapses, and the like) (S15).

When the condition is established (Yes in S15), the transmission region determining part 117 instructs the image compressing unit 114 to transfer error information. The image compressing unit 114 which receives the instruction calculates an error included in the compressed image data (previously transferred updated image information), generates error information and transfers it to the image transfer part 115 (S16).

When receiving the error information including the compression error, the image transfer unit 115 transmits the error information to the network N via the data transfer part 116 (S17).

When the condition is not established (No in S15), the error information is not transmitted, and processing of the updated image transmission is repeated.

As described above, according to the information transfer apparatus of this embodiment, error information of a compression error is generated with respect to the updated image information which is not updated even after a specified time elapses, and is transferred to the information receiving apparatus, and therefore, it becomes possible to regularly suppress image noise by the lossy compression method.

Now, with reference to FIGS. 3, 5 and 6, the image compressing unit 114 in the information transfer apparatus of the first embodiment will be described in detail.

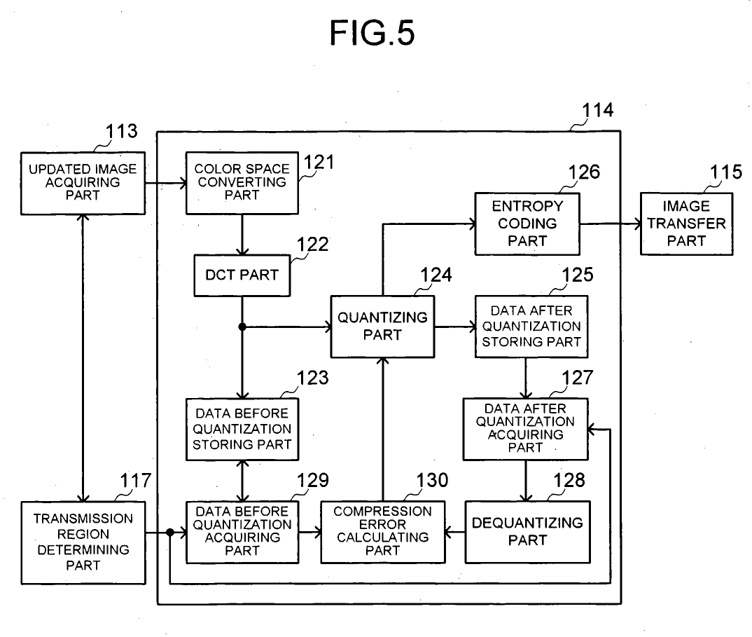

As shown in FIG. 5, the image compressing unit 114 in the information transfer apparatus 1 of this embodiment includes a color space converting part 121, a DCT part 122, a data before quantization storing part 123, a quantizing part 124, a data after quantization storing part 125, an entropy coding part 126, a data after quantization acquiring part 127, a dequantizing part 128, a data before quantization acquiring part 129, and a compression error calculating part 130.

The color space converting part 121 is converting means which performs conversion processing of the image data, which is expressed in an RGB color space, in the updated image information transferred from the updated image acquiring part 113 into a YCbCr color space. In the image information of a PC or the like, image data expressed in the RGB color space is generally used, but sensitivity of a human eye to color is not uniform among RGB. Thus, in the image compressing unit 114 of this embodiment, the compression effect of the image data is enhanced by converting the image data of the RGB color space into the image data of the YCbCr color space, and making it possible to exclude the region to which the sensitivity of a human eye is low.

The DCT part 122 is transforming means which performs discrete cosine transformation of the image data converted into the YCbCr color space in the color space converting part 121 to transform it into DCT coefficients for every frequency component. The quantizing part 124 is quantizing means which quantizes the image data transformed in the DCT part 122 and the image data transferred from the compression error calculating part 130 which will be described later based on a predetermined quantization table. The entropy coding part 126 is coding means which compresses/codes the image data transferred from the quantizing part 124 in accordance with Haffman code or the like. As the color space converting part 121, the DCT part 122, the quantizing part 124 and the entropy coding part 126, those similar to the respective components used in the JPEG method known as the lossy compression method can be used.

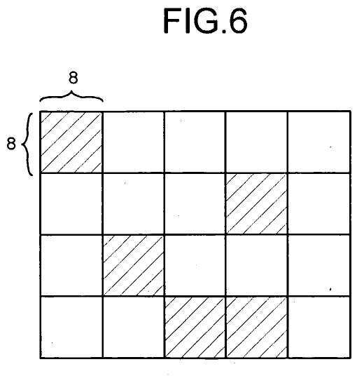

The data before quantization storing part 123 is data storing means which holds the image data (DCT coefficients) transformed by the DCT part 122 for a specified period. More specifically, the data before quantization storing part 123 is constructed by a frame buffer in a size corresponding to the resolution of the screen as shown in FIG. 6 to store the image data after DCT. Namely, the DCT part 122 of this embodiment performs orthogonal transformation with 8-by-8 pixels as one block, and therefore, the frame buffer of the data before quantization storing part 123 is blocked at every 8-by-8 pixels in advance. Then, the DCT part 122 writes the image data subjected to DCT into the frame buffer based on the positional information included in the updated image information.

The data after quantization storing part 125 is data storing means which holds the image data quantized by the quantizing part 124 for a specified period. More specifically, it is constructed by a frame buffer which is blocked every 8-by-8 pixels as shown in FIG. 6 as the data before quantization storing part 123. The quantizing part 124 writes the quantized image data into the frame buffer based on the positional information included in the updated image information.

The data before quantization acquiring part 129 is data reading means which acquires (extracts) image data stored in an instructed region of the data before quantization storing part 123 when it is instructed about the region to which the compression error should be transmitted by the transmission region determining part 117. The data after quantization acquiring part 127 is data reading means which acquires (extracts) image data held in an instructed region of the data after quantization storing part 125 when it is instructed about the region to which the compression error should be transmitted by the transmission region determining part 117.

The dequantizing part 128 is data after quantization dequantizing means which dequantizes the image data which is acquired by the data after quantization acquiring part 127 with the same quantization table as used in the quantizing part 124.

The compression error calculating part 130 is calculating means which calculates a difference between the image data acquired in the data before quantization acquiring part 129 and the image data generated in the dequantizing part 128 as a compression error. Namely, the difference between the image data held in the data before quantization storing part 123, which is the image data before inputted in the quantizing part 124, and the image data, which is reproduced from the image data outputted from the quantizing part 124 by the dequantizing part 128, becomes the compression error occurring in the quantizing part 124. The compression error calculating part 130 transfers the obtained compression error to the quantizing part 124.

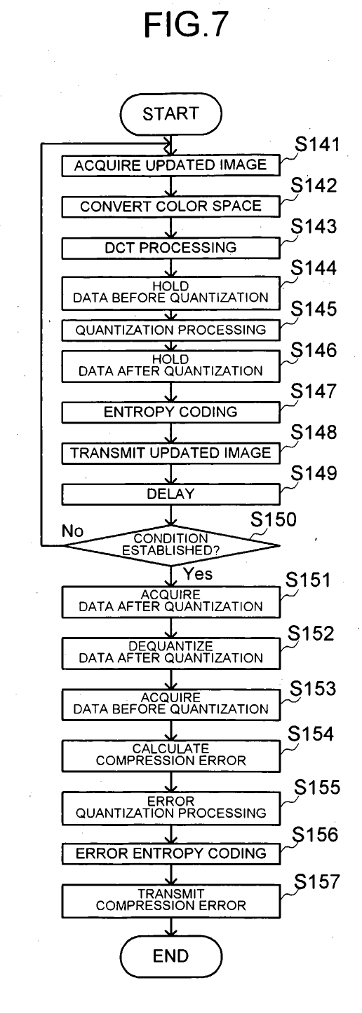

Next, referring to FIG. 7, an operation of the image compressing unit 114 of this embodiment shown in FIG. 5 will be described. When updated image information is inputted from the updated image acquiring part 113 (S141), the color space converting part 121 converts the color space of the image data of the updated image information into YCbCr from RGB (S142).

When the image data is converted into the YCbCr color space, the DCT part 122 performs DCT of the image data at every 8-by-8 pixels (S143).

After the DCT processing is performed, the DCT part 122 writes the transformed DCT coefficients into the corresponding region of the frame buffer divided at every 8-by-8 block of the data before quantization storing part 123 (S144). The DCT part 122 transfers the transformed DCT coefficients to the quantizing part 124.

When receiving the DCT coefficients, the quantizing part 124 quantizes the DCT coefficients (S145).

After the quantization processing is performed, the quantizing part 124 writes the quantized data into the corresponding region of the frame buffer of the data after quantization storing part 125 (S146). The quantizing part 124 transfers the quantized data to the entropy coding part 126.

The entropy coding part 126 performs entropy coding of the quantization result which is transferred (S147).

The entropy-coded data is transferred to the image transfer part 115, and the image transfer part 115 transfers the updated image information including the compressed image data (S148).

The transmission region determining part 117 monitors the updated image information which the updated image acquiring part 113 acquires, and waits until a specified time elapses (S149). The transmission region determining part 117 determines whether the predetermined condition (for example, the update region relating to the transferred updated image information is not updated yet after a specified time elapses, and the like) is established (S150).

When the condition is established (Yes in S150), the transmission region determining unit 117 instructs the data after quantization acquiring part 127 about the region of the data to be acquired. The data after quantization acquiring part 127 acquires data of the region where an error exists from the data after quantization held in the data after quantization storing part 125 (S151). The acquired data is transferred to the dequantizing part 128.

The dequantizing part 128 dequantizes the acquired data after quantization by using the same quantization table as the quantization table in the quantization processing in the quantizing part 124 (S152). The dequantized data is transferred to the compression error calculating part 130.

The data before quantization acquiring part 129 acquires the data of the same region (corresponding region) as the region where the data after quantization acquiring part 127 acquires the data from the data after quantization storing part 125, from the data before quantization held in the data before quantization storing part 123, based on the instruction from the transmission region determining part 117 (S153). The acquired data is transferred to the compression error calculating part 130.

The compression error calculating part 130 calculates a compression error between the acquired data before quantization and the data obtained by dequantizing the data after quantization, and the obtained compression error is transferred to the quantizing part 124 (S154).

The quantifying part 124 further quantifies the transferred compression error, and transfers the quantified data to the entropy coding part 126 (S155).

The entropy coding part 126 entropy-codes the transferred quantized data, and transfers it to the image transfer part 115 (S156).

The image transfer part 115 which receives the coded data transmits error information including the compressed data of the obtained compression error (S157).

When the condition is not established (No in S150), the error information is not transmitted, and processing of the updated image transmission is repeated.

As described above, according to the information transfer apparatus of this embodiment, in the image compressing unit, an error at the time of quantization is calculated as error information, and transmits the error information after quantization/coding, and therefore, noise caused by lossy compression can be corrected.

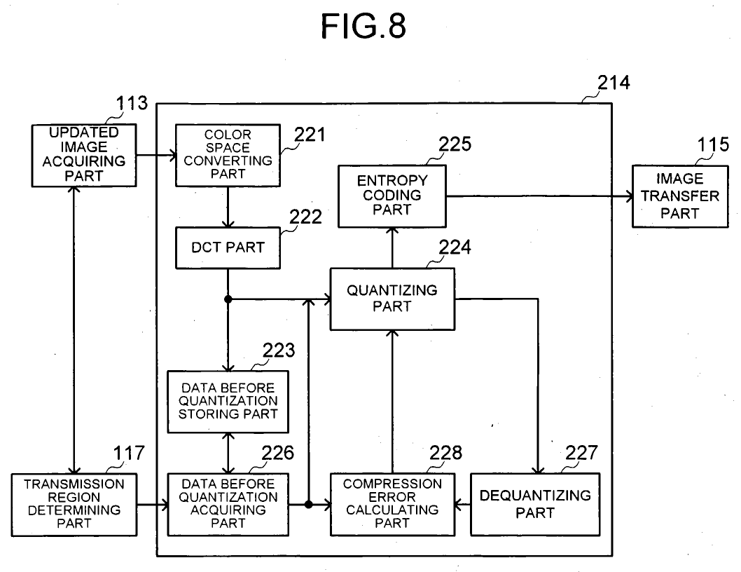

Subsequently, with reference to FIG. 8, an information transfer apparatus according to the second embodiment of the present invention will be described in detail. In the information transfer apparatus of this embodiment, the image compressing unit 114 of the information transfer apparatus of the first embodiment is replaced with an image compressing unit 214 shown in FIG. 8. Therefore, the components common with the first embodiment are shown by being assigned with the common reference numerals and characters, and the redundant explanation will be omitted. In the image compressing unit 114 of the first embodiment, the error information is calculated by holding both the data before quantization and the data after quantization, but the second embodiment differs from the first embodiment only in the respect that in the image compressing unit 214 of the second embodiment, only the data before quantization is held.

As shown in FIG. 8, the image compressing unit 214 of this embodiment includes a color space converting part 221, a DCT part 222, a data before quantization storing part 223, a quantizing part 224, an entropy coding part 225, a data before quantization acquiring part 226, a dequantizing part 227, and a compression error calculating part 228. The color space converting part 221, the DCT part 222, the data before quantization storing part 223, the quantizing part 224, the entropy coding part 225, the data before quantization acquiring part 226, the dequantizing part 227, and the compression error calculating part 228 respectively correspond to the color space converting part 121, the DCT part 122, the data before quantization storing part 123, the quantizing part 124, the entropy coding part 116, the data before quantization acquiring part 129, the dequantizing part 128, and the compression error calculating part 130, and have the common functions. Namely, the image compressing unit 214 of this embodiment has the configuration in which from the image compressing unit 114 of the first embodiment, the data after quantization storing part 125 and the data after quantization acquiring part 127 which are disposed between the quantizing part 124 and the dequantizing part 128 are omitted.

In the image compressing unit 214 of this embodiment, on the occasion of calculating a compression error, the data before quantization acquiring part 226 acquires data before quantization from the data before quantization storing part 223 based on the region instructed from the transmission region determining part 117. The data before quantization acquiring part 226 transfers the obtained data before quantization to the quantizing part 224 again, and the quantizing part 224 quantizes the transferred data. Then, the dequantizing part 227 dequantizes the quantized data, and transfers the dequantized data to the compression error calculating part 228. Namely, the data before quantization acquiring part 226 transfers the data before quantization to the compression error calculating part 228 and the quantizing part 224, and thereby, the compression error calculating part 228 calculates the compression error based on the difference between the data subjected to the quantizing/dequantizing processes and the data before quantization.

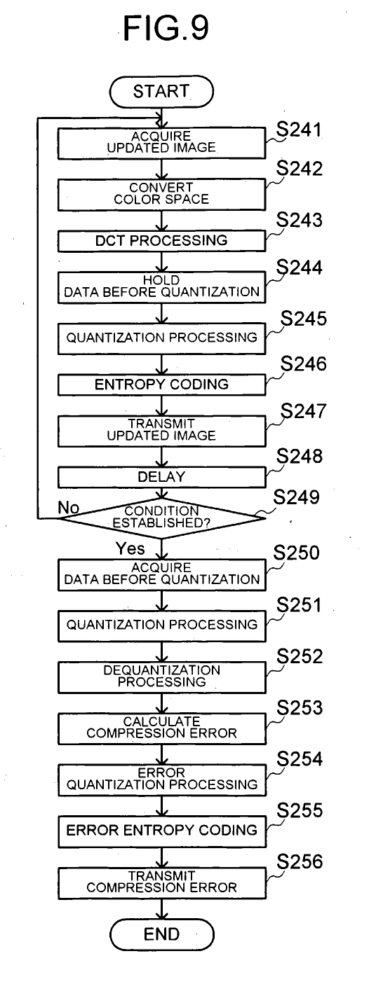

Next, referring to FIG. 9, an operation of the image compressing unit 214 of this embodiment shown in FIG. 8 will be described. When updated image information is inputted from the updated image acquiring unit 113 (S241), the color space converting part 221 converts the color space of the image data of the updated image information into YCbCr from RGB (S242).

When the image data is converted into the YCbCr color space, the DCT part 222 performs DCT of the image data at every 8-by-8 pixels (S243).

After the DCT processing is performed, the DCT part 222 writes the transformed DCT coefficients into the corresponding region of the frame buffer divided at every 8-by-8 block of the data before quantization storing part 223 (S244). The DCT part 222 transfers the transformed DCT coefficients to the quantizing part 224.

When receiving the DCT coefficients, the quantizing part 224 quantizes the DCT coefficients (S245). After the quantization processing is performed, the quantizing part 224 transfers the quantized data to the entropy coding part 225.

The entropy coding part 225 performs entropy coding of the quantization result which is transferred (S246).

The entropy-coded data is transferred to the image transfer part 115, and the image transfer part 115 transfers the updated image information including the compressed image data (S247).

The transmission region determining part 117 monitors the updated image information which the updated image acquiring part 113 acquires, and waits until a specified time elapses (S248). The transmission region determining part 117 determines whether the predetermined condition (for example, the update region relating to the transferred updated image information is not updated yet after a specified time elapses, and the like) is established (S249).

When the condition is established (Yes in S249), the data before quantization acquiring part 226 acquires data of the region where an error exists from the data before quantization which is held in the data before quantization storing part 223, based on the instruction of the transmission region determining part 117 (S250). The acquired data is transferred to the quantizing part 224 and the compression error calculating part 228.

When receiving the data of the region where the error exists, the quantizing part 224 performs quantization processing of the data (S251). The quantized data is transferred to the dequantizing part 227.

The dequantizing part 227 dequantizes the transferred data after quantization by using the same (corresponding) quantization table as the quantization table in the quantization processing in the quantizing part 224 (S252). The dequantized data is transferred to the compression error calculating part 228.

The compression error calculating part 228 calculates a compression error between the acquired data before quantification and the data obtained by dequantizing the data after quantification, and transfers the obtained compression error to the quantizing part 224 (S253).

The quantifying part 224 further quantifies the transferred compression error, and transfers the quantified data to the entropy coding part 225 (S254).

The entropy coding part 225 entropy-codes the transferred quantized data, and transfers it to the image transfer part 115 (S255).

The image transfer unit 115 which receives the coded data transmits error information including the compressed data of the obtained compression error (S256).

When the condition is not established (No in S249), the error information is not transmitted, and processing of the updated image transmission is repeated.

According to the information transfer apparatus of this embodiment, the image compression part has the configuration which holds only the data before quantization. Therefore, the memory utilization corresponding to the frame buffer which holds the data after quantization can be curtailed.

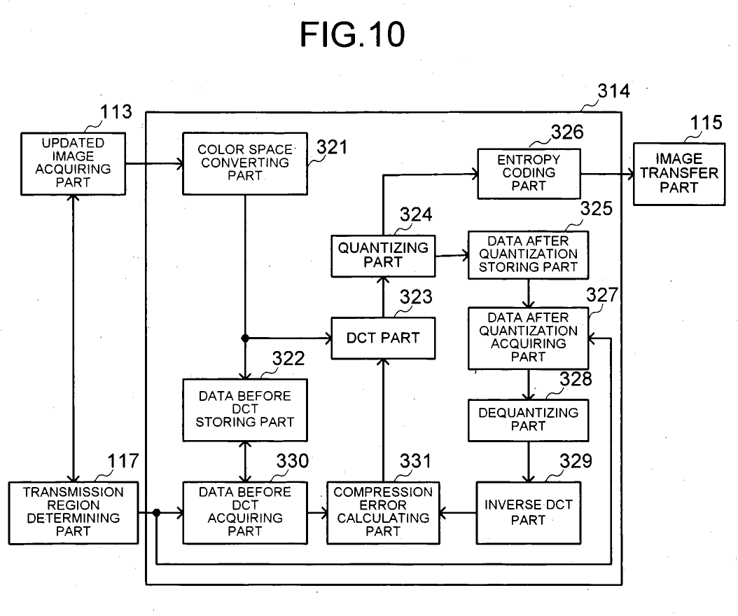

Subsequently, with reference to FIG. 10, an information transfer apparatus according to the third embodiment of the present invention will be described in detail. The information transfer apparatus of this embodiment differs from first embodiment in the respect that a compression error is obtained based on the data before and after DCT, while in the first embodiment the compression error is obtained based on the data before and after quantization. Thus, the components common with the first embodiment are shown by being assigned with the common reference numerals and characters, and the redundant explanation will be omitted.

As shown in FIG. 10, the image compressing unit 314 of this embodiment includes a color space converting part 321, a data before DCT storing part 322, a DCT part 323, a quantizing part 324, a data after quantization storing part 325, an entropy coding part 326, a data after quantization acquiring part 327, a dequantizing part 328, an inverse DCT part 329, a data before DCT acquiring part 330, and a compression error calculating part 331. The color space converting part 321, the DCT part 323, the quantizing part 324, the data after quantization storing part 325, the entropy coding part 326, the data after quantization acquiring part 327, the dequantizing part 328, and the compression error calculating part 331 respectively correspond to the color space converting part 121, the DCT part 122, the quantizing part 124, the data after quantization storing part 125, the entropy coding part 126, the data after quantization acquiring part 127, the dequantizing part 128, and the compression error calculating part 130, and have the common functions. Namely, the image compressing unit 314 of this embodiment has the configuration in which the data before DCT storing part 322 and the data before DCT acquiring part 330 are included in the image compressing unit 114 of the first embodiment in place of the data before quantization storing part 123 and the data before quantization acquiring part 129, and the inverse DCT part 329 is further included.

The data before DCT storing part 322 is data storing means which stores a color space conversion data transferred from the color space converting part 321 that is pre-processing of the DCT part 323 for a specified period. The data before DCT acquiring part 330 is data reading means which acquires the image data held in the instructed region of the data before DCT storing part 322 when it is instructed about the region to which the compression error should be transmitted by the transmission region determining part 117. The inverse DCT part 329 is transforming means which performs inverse DCT of the dequantized data (DCT coefficients) about the error information transferred by the dequantizing part 328 and transfers the transformed data to the compression error calculating part 331.

In the image compressing unit 314 of this embodiment, on the occasion of calculating a compression error, the data after quantization acquiring part 327 acquires data after quantization from the data after quantization storing part 325 based on the region about which it is instructed by the transmission region determining part 117. The data after quantization acquiring part 327 transfers the obtained data after quantization to the dequantizing part 328, and the dequantizing part 328 dequantizes the transferred data and transfers it to the inverse DCT part 329. Then, the inverse DCT part 329 performs inverse DCT of the transferred data, and transfers it to the compression error calculating part 331.

Meanwhile, the data before DCT acquiring part 330 acquires the image data of the region corresponding to the region of the image data, which the data after quantization acquiring part 327 acquires, from the data before DCT storing part 322 based on the instruction from the transmission region determining part 117, and transfers it to the compression error calculating part 331. As a result, the compression error calculating part 331 calculates the difference between the data transferred from the inverse DCT part 329 and the data of the corresponding region stored in the data before DCT storing part 322, and thereby, can obtain the compression error.

As described above, in the information transfer apparatus of this embodiment, a compression error is obtained from the difference between the data subjected to the DCT/inverse DCT processes in addition to the quantization/dequantization processes, and the data before DCT. Namely, it becomes possible to obtain the compression error with the error accompanying the DCT added in addition to the error due to quantization processing in the image compression part.

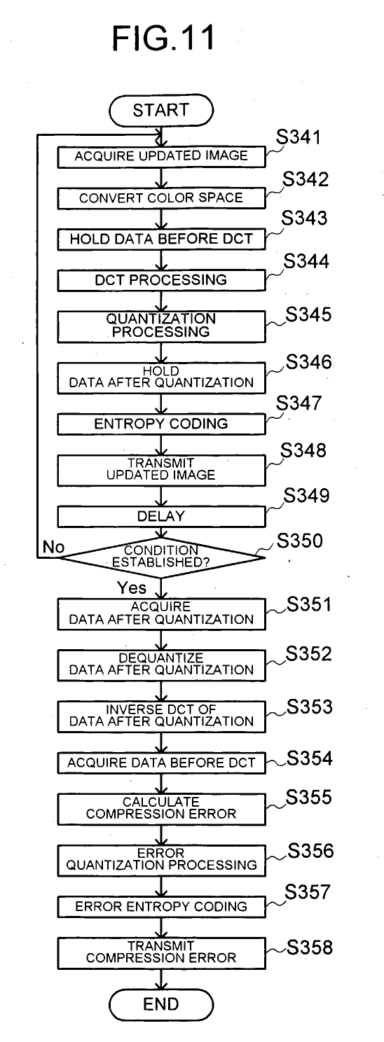

Next, referring to FIG. 11, an operation of the image compressing unit 314 of this embodiment shown in FIG. 10 will be described. FIG. 11 is a flow chart shoring an operation of the image compressing unit 314 in the information transfer apparatus of this embodiment.

When updated image information is inputted from the updated image acquiring part 113 (S341), the color space converting part 321 converts the color space of the image data of the updated image information into YCbCr from RGB (S342).

When the image data is converted into the YCbCr color space, the color space converting part 321 writes the converted image data (data before DCT) into the data before DCT storing part 322 (S343). The color space converting part 321 also transfers the converted image data to the DCT part 323.

When receiving the image data, the DCT part 323 performs DCT of the image data at every 8 by 8 pixels (S344). After the DCT processing is performed, the DCT part 323 transfers the transformed DCT coefficients to the quantizing part 324.

When receiving the DCT coefficients, the quantizing part 324 quantizes the DCT coefficients (S345).

After the quantization processing is performed, the quantizing part 324 writes the quantized data into the corresponding region of the frame buffer of the data after quantization storing part 325 (S346). The quantizing part 324 transfers the quantized data to the entropy coding part 326.

The entropy coding part 326 entropy-codes the transferred quantization result (S347).

The entropy-coded data is transferred to the image transfer part 115, and the image transfer part 115 transfers the updated image information including the compressed image data (S348).

The transmission region determining part 117 monitors the updated image information which the updated image acquiring part 113 acquires, and waits until a specified time elapses (S349). The transmission region determining part 117 determines whether the predetermined condition (for example, the update region relating to the transferred updated image information is not updated yet after a specified time elapses, and the like) is established (S350).

When the condition is established (Yes in S350), the transmission region determining part 117 instructs the data after quantization acquiring part 327 on the data region which it should acquire. The data after quantization acquiring part 327 acquires data of the region where an error exists from the data after quantization which is held in the data after quantization storing part 325 (S351). The acquired data is transferred to the dequantizing part 328.

The dequantizing part 328 dequantizes the acquired data after quantization by using the same quantization table as the quantization table in the quantization processing in the quantizing part 324 (S352). The dequantized data is transferred to the inverse DCT part 329.

The inverse DCT part 329 performs inverse DCT of the transferred data (DCT coefficients) to generate image data, and transfers it to the compression error calculating part 331 (S353).

The data before DCT acquiring part, 330 acquires the data of the same region (corresponding region) as the region in which the data after quantization acquiring part 327 acquires the data from the data after quantization storing part 325, from the data before DCT held in the data before quantization storing part 322, based on the instruction from the transmission region determining part 117 (S354). The acquired data is transferred to the compression error calculating part 331.

The compression error calculating part 331 calculates a compression error between the acquired data before DCT and the data obtained by subjecting the data after quantization to dequantization/inverse DCT, and transfers the obtained compression error to the DCT part 323 (S355).

The DCT part 323 performs DCT of the transferred compression error and transfers it to the quantizing part 324, and the quantizing part 324 quantizes the transferred DCT coefficients and transfers them to the entropy coding part 326 (S356).

The entropy coding part 326 entropy-codes the transferred quantized data, and transfers it to the image transfer part 115 (S357).

The image transfer part 115 which receives the coded data transmits error information including the compressed data of the obtained compression error (S358).

When the condition is not established (No in S350), the error information is not transmitted, and processing of the updated image transmission is repeated.

According to the information transfer apparatus of this embodiment, the configuration of generating error information with a DCT error added in addition to a quantization error is included, and therefore, accuracy of error information can be enhanced.

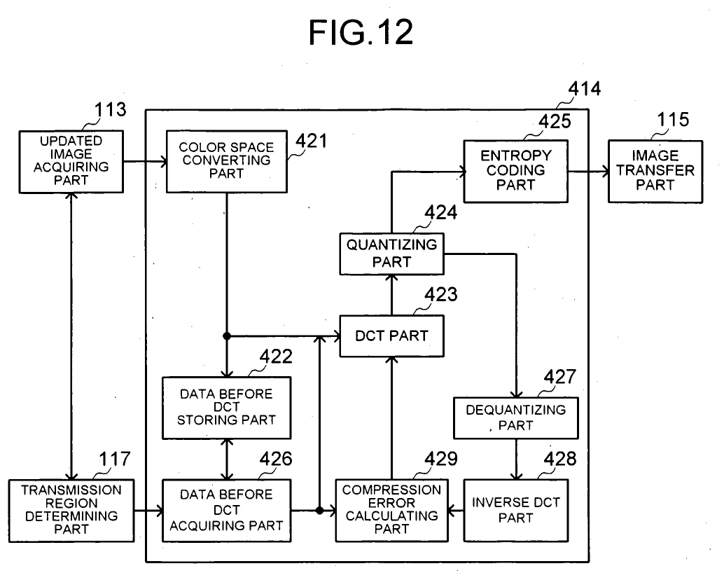

Subsequently, an information transfer apparatus according to the fourth embodiment of the present invention will be described in detail with reference to FIG. 12. In the information transfer apparatus of this embodiment, the image compressing unit 314 of the image transfer apparatus of the third embodiment is replaced with an image compressing unit 414 shown in FIG. 12. Thus, the components common with the third embodiment will be assigned with the common reference numerals and characters, and the redundant explanation will be omitted. The fourth embodiment differs from the third embodiment in the respect that while in the image compressing unit 314 of the third embodiment, error information is calculated with the data before DCT and the data after quantization held, in the image compressing unit 414 of the fourth embodiment, only the data before DCT before DCT is held.

As shown in FIG. 12, the image compressing unit 414 of this embodiment includes a color space converting part 421, a data before DCT storing part 422, a DCT part 423, a quantizing part 424, an entropy coding part 425, a dequantizing part 427, an inverse DCT part 428, a data before DCT acquiring part 426, and a compression error calculating part 429. The color space converting part 421, the data before DCT storing part 422, the DCT part 423, the quantizing part 424, the entropy coding part 425, the dequantizing part 427, the inverse DCT part 428, the data before DCT acquiring part 426, and the compression error calculating part 429 respectively correspond to the color space converting part 321, the data before DCT storing part 322, the DCT part 323, the quantizing part 324, the entropy coding part 326, the dequantizing part 328, the inverse DCT part 329, the data before DCT acquiring part 330 and the compression error calculating part 331, and have the common functions. Namely, the image compressing unit 414 of this embodiment has the configuration in which the data after quantization storing part 325 and the data after quantization acquiring part 327 are omitted from the image compressing unit 314 of the third embodiment.

In the image compressing unit 414 in this embodiment, the data before DCT acquiring part 426 acquires the data before DCT from the data before DCT storing part 422 based on the region on which it is instructed by the transmission region determining part 117 when calculating a compression error. The data before DCT acquiring part 426 transfers the acquired data before DCT to the DCT part 423 and the compression error calculating part 429. The DCT part 423 performs DCT of the transferred data. The data subjected to DCT is transferred to the quantizing part 424, and the quantizing part 424 quantizes the transferred data. The dequantizing part 427 dequantizes the quantized data, and transfers the dequantized data to the inverse DCT part 428. The inverse DCT part 428 performs inverse DCT of the transferred data, and transfers the obtained image data to the compression error calculating part 429. Namely, the data before DCT acquiring part 426 transfers the data before DCT to the compression error calculating part 429 and the DCT part 423, whereby the compression error calculating part 429 calculates the compression error based on the difference between the data subjected to DCT/quantization/dequantization/inverse DCT processes and the data before DCT.

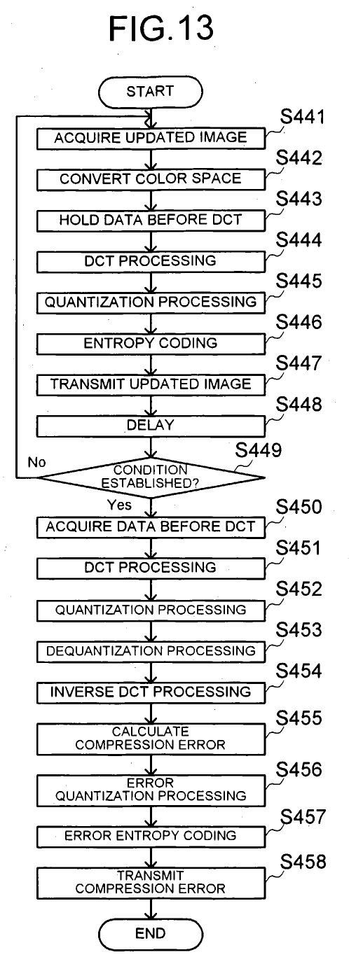

Next, referring to FIG. 13, an operation of the image compressing unit 414 of this embodiment shown in FIG. 12 will be described. FIG. 13 is a flow chart showing an operation of the image compressing unit 414 in the information transfer apparatus of this embodiment.

When updated image information is inputted from the updated image acquiring part 113 (S441), the color space converting part 421 converts the color space of the image data of the updated image information into YCbCr from RGB (S442).

When the image data is converted into the YCbCr color space, the color space converting part 421 writes the converted image data (data before DCT) into the data before DCT storing part 422 (S443). The color space converting part 421 also transfers the converted image data to the DCT part 423.

When receiving the image data, the DCT part 423 performs DCT of the image data at every 8 by 8 pixels (S444). After the DCT processing is performed, the DCT part 423 transfers the transformed DCT coefficients to the quantizing part 424.

When receiving the DCT coefficients, the quantizing part 424 quantizes the DCT coefficients (S445). After the quantization processing is performed, the quantizing part 424 transfers the quantized data to the entropy coding part 425.

The entropy coding part 425 entropy-codes the transferred quantization result (S446).

The entropy-coded data is transferred to the image transfer part 115, and the image transfer part 115 transfers the updated image information including the compressed image data (S447).

The transmission region determining part 117 monitors the updated image information which the updated image acquiring part 113 acquires, and waits until a specified time elapses (S448). The transmission region determining part 117 determines whether the predetermined condition (for example, the update region relating to the transferred updated image information is not updated yet after a specified time elapses, and the like) is established (S449).

When the condition is established (Yes in S449), the transmission region determining part 117 instructs the data before DCT acquiring part 426 about the data region which it should acquire. The data before DCT acquiring part 426 acquires data of the region where an error exists from the data before DCT which is held in the data before DCT storing part 422 (S450). The acquired data is transferred to the DCT part 423 and the compression error calculating part 429.

When receiving the data of the region where the error exits, the DCT part 423 performs DCT of the data (S451). The obtained DCT coefficients are transferred to the quantizing part 424.

When receiving the DCT coefficients, the quantizing part 424 performs quantization processing of the data (S452). The quantized data is transferred to the dequantizing part 427.

The dequantizing part 427 dequantizes the transferred data after quantization by using the same (corresponding) quantization table as the quantization table in the quantization processing in the quantizing part 424 (S453). The dequantized data is transferred to the inverse DCT part 428.

When receiving the dequantized DCT coefficients, the inverse DCT part 428 performs inverse DCT of the data, and transfers the obtained image data to the compression error calculating part 429 (S454).

The compression error calculating part 429 calculates a compression error between the acquired data before DCT and the data obtained by subjecting the obtained data before DCT to DCT/quantization/dequantization/inverse DCT, and transfers the obtained compression error to the DCT part 423 (S455).

The DCT part 423 further performs DCT of the transferred compression error and transfers it to the quantizing part 424. The quantizing part 424 further quantizes the compression error transferred from the DCT part 423 and transfers the quantized data to the entropy coding part 425 (S456).

The entropy coding part 425 entropy-codes the transferred quantized data, and transfers it to the image transfer part 115 (S457).

The image transfer part 115 which receives the coded data transmits error information including the compressed data of the obtained compression error (S458).

When the condition is not established (No in S449), the error information is not transmitted, and processing of the updated image transmission is repeated.

According to the information transfer apparatus of this embodiment, the configuration of generating error information with a DCT error added in addition to a quantization error is included, and therefore, accuracy of the error information can be enhanced. Further, as in the second embodiment, it is not necessary to prepare a frame buffer in which the data after quantization is held, and therefore, memory utilization can be curtailed.

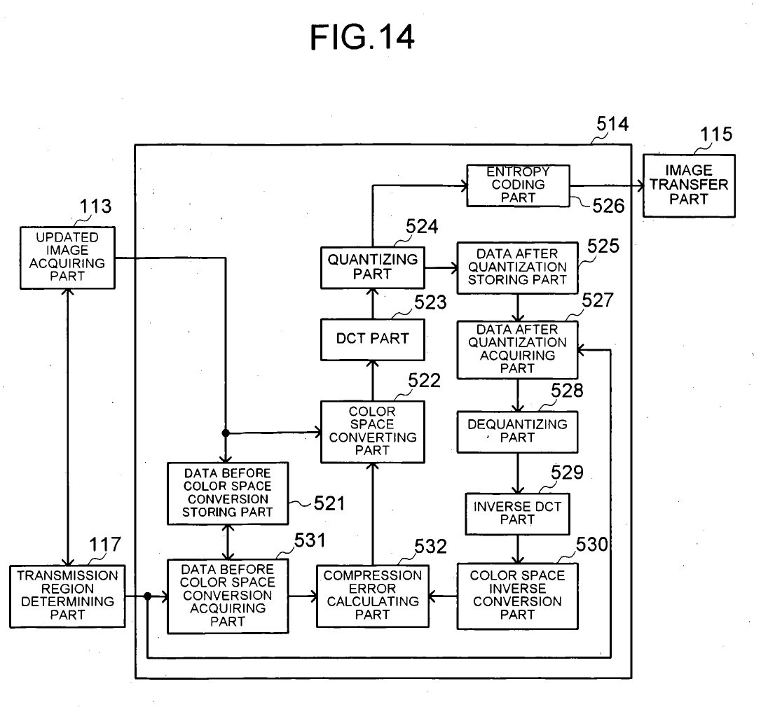

Subsequently, an information transfer apparatus according to the fifth embodiment of the present invention will be described in detail with reference to FIG. 14. The information transfer apparatus of this embodiment differs from the first embodiment and the third embodiment in the respect that a compression error is obtained based on the data before and after color space conversion while in the first embodiment, the compression error is obtained based on the data before and after quantization, and in the third embodiment, the compression error is obtained based on the data before and after DCT. Thus, the components common with the first and the third embodiments will be assigned with the common reference numerals and characters, and the redundant explanation will be omitted.

As shown in FIG. 14, the image compressing unit 514 of this embodiment includes a data before color space conversion storing part 521, a color space converting part 522, a DCT part 523, a quantizing part 524, a data after quantization storing part 525, an entropy coding part 526, a data after quantization acquiring part 527, a dequantizing part 528, an inverse DCT part 529, a color space inverse conversion part 530, a data before color space conversion acquiring part 531, and a compression error calculating part 532. The color space converting part 522, the DCT part 523, the quantizing part 524, the data after quantization storing part 525, the entropy coding part 526, the data after quantization acquiring part 527, the dequantizing part 528, and the compression error calculating part 523 respectively correspond to the color space converting part 121, the DCT part 122, the quantizing part 124, the data after quantization storing part 125, the entropy coding part 126, the data after quantization acquiring part 127, the dequantizing part 128, and the compression error calculating part 130, and have the common functions. The inverse DCT part 529 corresponds to the inverse DCT part 329 in the third embodiment, and has the common function.

Namely, the image compressing unit 514 of this embodiment has the configuration including the data before color space conversion storing part 521 and the data before color space conversion acquiring part 531 in place of the data before quantization storing part 123 and the data before quantization acquiring part 129 of the image compressing unit 114 of the first embodiment, and further including the inverse DCT part 529 and the color space inverse conversion part 530.

The data before color space conversion storing part 521 is data storing means which holds the updated image data transferred from the updated image acquiring part 113, which is the pre-processing of the color space converting part 522, for a specified period. The data before color space conversion acquiring part 531 is data reading means which acquires image data held in the instructed region of the data before color conversion storing part 521 when it is instructed about the region to which the compression error should be transmitted by the transmission region determining part 117. The color space inverse conversion part 530 is converting means which performs color space conversion of the image data with respect to the error information transferred from the inverse DCT part 529 in the reverse direction from the color space converting part 522, and transfers the converted data to the compression error calculating part 532.

In the image compressing unit 514 in this embodiment, the data after quantization acquiring part 527 acquires the data after quantization from the data after quantization storing part 525 based on the region about which it is instructed by the transmission region determining part 117 when calculating a compression error. The data after quantization acquiring part 527 transfers the acquired data after quantization to the dequantizing part 528, and the dequantizing part 528 dequantizes the transferred data and transfers it to the inverse DCT part 529. The inverse DCT part 529 performs inverse DCT of the transferred data, and transfers it to the color space inverse conversion part 530. Further, the color space inverse conversion part 530 executes color space inverse conversion of the transferred image data, and transfers the converted data to the compression error calculating part 532.

Meanwhile, the data before color space conversion acquiring part 531 acquires the image data of the region corresponding to the region of the image data, which is acquired by the data after quantization acquiring part 527, from the data before color space conversion storing part 521, and transfers it to the compression error calculating part 532. As a result, the compression error calculating part 532 can obtain the compression error by calculating the difference between the data transferred from the color space inverse conversion part 530 and the data of the corresponding region in which the data before color space conversion storing part 521.

As described above, in the information transfer apparatus of this embodiment, a compression error is obtained from the difference between the data subjected to the color space conversion/color space inverse conversion in addition to the quantization/dequantization processes and the DCT/inverse DCT processes. Namely, in the image compressing unit, it becomes possible to obtain the compression error to which an error accompanying color space conversion is added in addition to an error due to the quantization processing, and an error accompanying DCT.

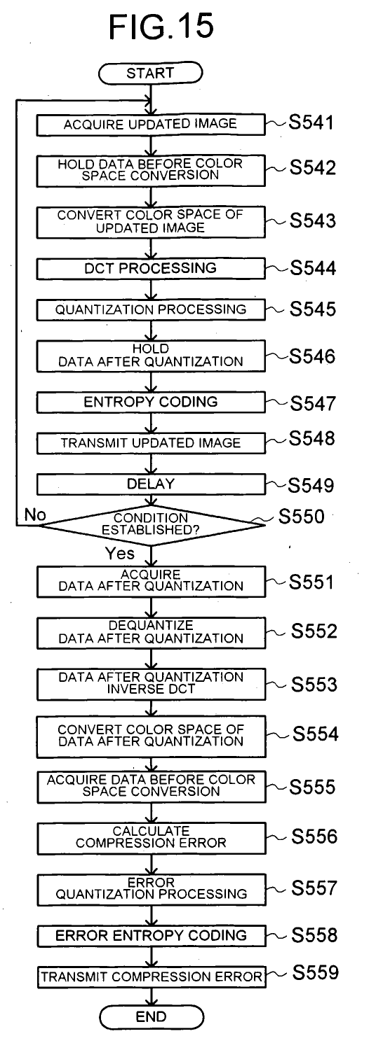

Next, referring to FIG. 15, an operation of the image compressing unit 514 of this embodiment shown in FIG. 14 will be described. When updated image information is inputted from the updated image acquiring part 113 (S541), the updated image information is inputted to the data before color space conversion storing part 521 and the color space converting part 522. The data before color space conversion storing part 521 stores the image data of the inputted updated image information (S542).

Meanwhile, the color space converting part 522 converts the color space of the image data of the inputted updated image information into YCbCr from RGB (S543). When the image data is converted into the YCbCr color space, the color space converting part 522 transfers the converted image data to the DCT part 523.

When receiving the image data, the DCT part 523 performs DCT of the image data at every 8 by 8 pixels (S544). After the DCT processing is performed, the DCT part 523 transfers the transformed DCT coefficients to the quantizing part 524.

When receiving the DCT coefficients, the quantizing part 524 quantizes the DCT coefficients (S545).

After the quantization processing is performed, the quantizing part 524 writes the quantized data into the corresponding region of the frame buffer of the data after quantization storing part 525 (S546). The quantizing part 524 transfers the quantized data to the entropy coding part 526.

The entropy coding part 526 entropy-codes the transferred quantization result (S547).

The entropy-coded data is transferred to the image transfer part 115, and the image transfer part 115 transfers the updated image information including the compressed image data (S548).

The transmission region determining part 117 monitors the updated image information which the updated image acquiring unit 113 acquires, and waits until a specified time elapses (S549). The transmission region determining part 117 determines whether the predetermined condition (for example, the update region relating to the transferred updated image information is not updated yet after a specified time elapses, and the like) is established (S550).

When the condition is established (Yes in S550), the transmission region determining part 117 instructs the data after quantization acquiring part 527 about the data region which it should acquire. The data after quantization acquiring part 527 acquires the data of the region in which the error exists from the data after quantization which is held in the data after quantization storing, part 525 (S551). The acquired data is transferred to the dequantizing part 528.

The dequantizing part 528 dequantizes the acquired data after quantization by using the same quantization table as the quantization table in the quantization processing in the quantizing part 524 (S552). The dequantized data is transferred to the inverse DCT part 529.

The inverse DCT part 529 performs inverse DCT of the transferred data (DCT coefficients), generates image data (data before DCT), and transfers it to the color space inverse conversion part 530 (S553).

When receiving the image data, the color space inverse conversion part 530 performs color space conversion of the image data in the reverse direction from the color space converting part 522, and transfers the converted data to the compression error calculating part 532 (S554).

The data before color space conversion acquiring part 531 acquires the data of the same region (corresponding region) as the region, in which the data after quantization acquiring part 527 acquires the data from the data after quantization storing part 525, from the data before color space conversion held in the data before color space conversion storing part 521, based on the instruction from the transmission region determining part 117 (S555). The acquired data is transferred to the compression error calculating part 532.

The compression error calculating part 532 calculates the compression error between the acquired data before color space conversion and the data obtained by subjecting the data after quantization to dequantization/inverse DCT/color space inverse conversion, and transfers the obtained compression error to the color space converting part 522 (S556).

The color space converting part 522 performs color space conversion of the image data relating to the transferred compression error, and transfers it to the DCT part 523, and the DCT part 523 performs DCT of the transferred compression error, and transfers it to the quantizing part 524. The quantizing part 524 quantizes the transferred DCT coefficients, and transfers them to the entropy coding part 526 (S557).

The entropy coding part 526 entropy-codes the transferred quantized data, and transfers it to the image transfer part 115 (S558).

The image transfer part 115 which receives the coded data transmits error information including the compressed data of the obtained compression error (S559).

When the condition is not established (No in S550), the error information is not transmitted, and processing of the updated image transmission is repeated.

According to the information transfer apparatus of this embodiment, the configuration of generating error information to which a color space conversion error is added in addition to the quantization error/DCT error is included, and therefore, accuracy of error information can be enhanced.

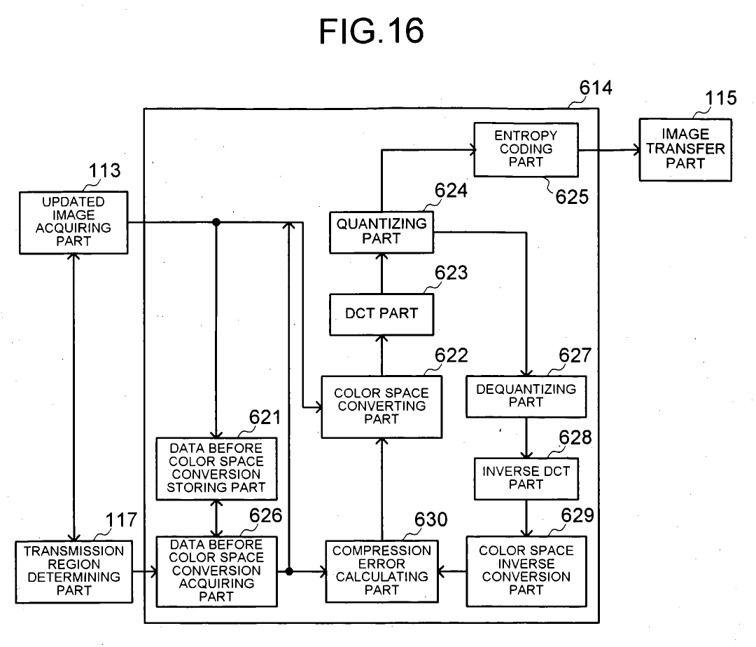

Subsequently, an information transfer apparatus according to the sixth embodiment of the present invention will be described in detail with reference to FIG. 16. In the information transfer apparatus of this embodiment, the image compressing unit 514 in the information transfer apparatus of the fifth embodiment is replaced with an image compressing unit 614 shown in FIG. 16. Thus, the components common with the fifth embodiment will be assigned with the common reference numerals and characters, and the redundant explanation will be omitted. The sixth embodiment differs from the fifth embodiment in the respect that the image compressing unit 514 of the fifth embodiment holds the data before color space conversion and data after quantization, and calculates error information, but the image compressing unit 614 of the sixth embodiment holds only data before color space conversion before color space conversion.

As shown in FIG. 16, the image compressing unit 614 of this embodiment includes a data before color space conversion storing part 621, a color space converting part 622, a DCT part 623, a quantizing part 624, an entropy coding part 625, a dequantizing part 627, an inverse DCT part 628, a color space inverse conversion part 629, a data before color space conversion acquiring part 626, and a compression error calculating part 630. The color space converting part 622, the DCT part 623, the quantizing part 624, the entropy coding part 625, the dequantizing part 627, and the compression error calculating part 630 respectively correspond to the color space converting part 121, the DCT part 122, the quantizing part 124, the entropy coding part 126, the dequantizing part 128, and the compression error calculating part 130, and have the common functions. The data before color space conversion storing part 621, the data before color space conversion acquiring part 626, and the inverse DCT part 628 correspond to the data before color space conversion storing part 521, the data before color space conversion acquiring part 531, and the inverse DCT part 529 in the fifth embodiment, and have the common functions.

Namely, the image compressing unit 614 of this embodiment has the configuration of the image compressing unit 514 of the fifth embodiment from which the data after quantization storing part 525 and the data after quantization acquiring part 527 are omitted.

In the image compressing unit 614 in this embodiment, the data before color space conversion acquiring part 626 acquires the data before color space conversion from the data before color space conversion storing part 621 based on the region about which it is instructed by the transmission region determining part 117 when calculating a compression error. The data before color space conversion acquiring part 626 transfers the acquired data before color space conversion to the color space converting part 622 and the compression error calculating part 630. The color space converting part 622 performs color space conversion of the transferred data and transfers it to the DCT part 623, and the DCT part 623 performs DCT of the transferred data. The data subjected to DCT is transferred to the quantizing part 624, and the quantizing part 624 quantizes the transferred data. The dequantizing part 627 dequantizes the quantized data, and transfers the dequantized data to the inverse DCT part 628. The inverse DCT part 628 performs inverse DCT of the transferred data, and transfers the obtained image data to the color space inverse conversion part 629. The color space inverse conversion part 629 performs color space conversion in the reverse direction from the color space converting part 622, and transfers the converted image data to the compression error calculating part 630. Namely, the data before color space conversion acquiring part 626 transfers the data before color space conversion to the compression error calculating part 630, and the color space converting part 622, whereby the compression error calculating part 630 calculates a compression error based on the difference between the data subjected to color space conversion/DCT/quantization/dequantization/inverse DCT/color space inverse conversion processes, and the data before color space conversion.

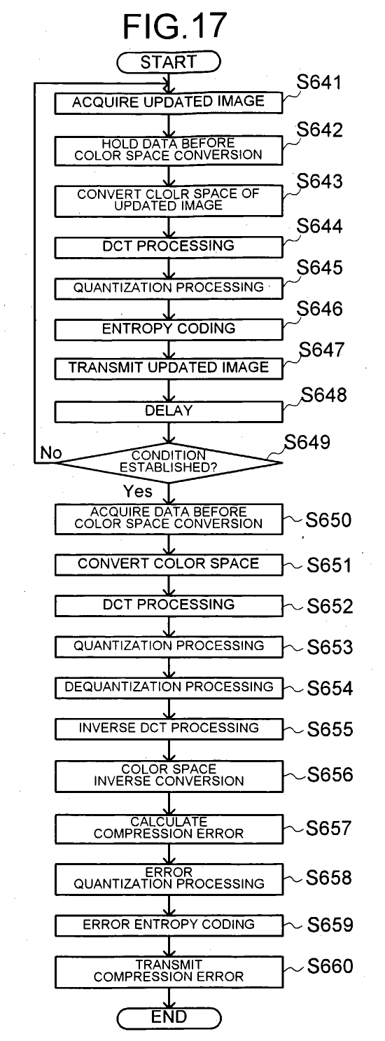

Next, referring to FIG. 17, an operation of the image compressing unit 614 of this embodiment shown in FIG. 16 will be described. When updated image information is inputted from the updated image acquiring unit 113 (S641), the updated image information is inputted to the data before color space conversion storing part 621 and the color space converting part 622. The data before color space conversion storing part 621 stores the image data of the inputted updated image information (S642).

Meanwhile, the color space converting part 622 converts the color space of the image data of the inputted updated image information to YCbCr from RGB (S643). When the image data is converted into the YCbCr color space, the color space converting part 622 transfers the converted image data to the DCT part 623.

When receiving the image data, the DCT part 623 performs DCT of the image data at every 8 by 8 pixels (S644). After the DCT processing is performed, the DCT part 623 transfers the transformed DCT coefficients to the quantizing part 624.

When receiving the DCT coefficients, the quantizing part 624 quantizes the DCT coefficients (S645). After the quantization processing is performed, the quantizing part 624 transfers the quantized data to the entropy coding part 625.

The entropy coding part 625 entropy-codes the transferred quantization result (S646).

The entropy-coded data is transferred to the image transfer unit 115, and the image transfer unit 115 transfers the updated image information including the compressed image data (S647).

The transmission region determining unit 117 monitors the updated image information which the updated image acquiring part 113 acquires, and waits until a specified time elapses (S648). The transmission region determining part 117 determines whether the predetermined condition (for example, the update region relating to the transferred updated image information is not updated yet after a specified time elapses, and the like) is established (S649).

When the condition is established (Yes in S649), the transmission region determining part 117 instructs the data before color space conversion acquiring part 626 about the data region which it should acquire. The data before color space conversion acquiring part 626 acquires the data of the region in which the error exists from the data before color space conversion which is held in the data before color space conversion storing part 621 (S650). The acquired data is transferred to the color space converting part 622 and the compression error calculating part 630.

When receiving the data of the region in which the error exists, the color space converting part 622 performs color space conversion of the data (S651). The data subjected to color space conversion is transferred to the DCT part 623.

When receiving the data subjected to color space conversion, the DCT part 623 performs DCT of the data (S652). The obtained DCT coefficients are transferred to the quantizing part 624.

When receiving the DCT coefficients, the quantizing part 624 performs quantization processing of the data (S653). The quantized data is transferred to the dequantizing part 627.

The dequantizing part 627 dequantizes the transferred data after quantization by using the same (corresponding) quantization table as the quantization table in the quantization processing in the quantizing part 624 (S654). The dequantized data is transferred to the inverse DCT part 628.

When receiving the dequantized DCT coefficients, the inverse DCT part 628 performs inverse DCT of the data, and transfers the obtained image data to the color space inverse conversion part 629 (S655).

When receiving the image data, the color space inverse conversion part 629 performs color space conversion in the reverse direction from the color space converting part 622, and the data subjected to color space inverse conversion is transferred to the compression error calculating part 630 (S656).

The compression error calculating part 630 calculates the compression error between the acquired data before color space conversion, and the data obtained by subjecting the acquired data before color space conversion to color space conversion/DCT/quantization/dequantization/inverse DCT/color space inverse conversion, and transfers the obtained compression error to the color space converting part 622 (S657).

When receiving the compression error, the color space converting part 622 further performs color space conversion of the image data relating to the compression error, and transfers it to the DCT part 623, and the DCT part 623 further performs DCT of the transferred compression error, and transfers it to the quantizing part 624. The quantizing part 624 further quantizes the compression error transferred from the DCT part 623, and transfers the quantized data to the entropy coding part 625 (S658).

The entropy coding part 625 entropy-codes the transferred quantized data, and transfers it to the image transfer unit 115 (S659).

The image transfer unit 115 which receives the coded data transmits error information including the compressed data of the obtained compression error (S660).

When the condition is not established (No in S649), the error information is not transmitted, and processing of updated image transmission is repeated.

According to the information transfer apparatus of this embodiment, the configuration of generating error information to which a color space conversion error is added in addition to a quantization error and a DCT error is included, and therefore, accuracy of error information can be enhanced. Further, as in the second and the fourth embodiments, it is not necessary to prepare a frame buffer in which the data after quantization is held, and therefore, memory utilization can be curtailed.

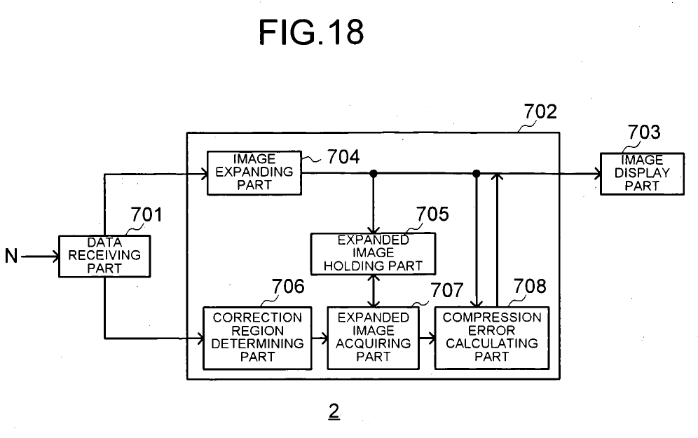

Next, an information receiving apparatus according to the seventh embodiment of the present invention will be described in detail. As shown in FIG. 18, the information receiving apparatus 2 of this embodiment includes a data receiving part 701, a received data processing unit 702 and an image display part 703. The received data processing unit 702 includes an image expansion part 704, an expanded image holding part 705, a correction region determining part 706, an expanded image acquiring part 707, and a compression error calculating part 708.

The data receiving part 701 is interface means which receives image information transferred via a network N. The data receiving part 701 corresponds to the data transfer unit 116 in the information transfer apparatuses of the first to sixth embodiments, and interface means such as Ethernet (registered trademark) can be used. The data receiving part 701 also has the function of separating updated image information and compression error image information, and correction region information indicating an error correction region included in the compression error image information, and transferring them respectively to the image expansion part 704 and the correction region determining part 706.

The image expansion part 704 is data expansion means which performs expansion processing of the compressed image information transferred from the network N by an expansion method corresponding to the compression method applied to the compressed image information. When the content is an updated image as a result of expanding the received compressed image information, the image expansion part 704 transfers the expanded content to the expanded image holding part 705 and the image display part 703. On the other hand, when the content is a compression error as a result of expanding the received compressed image information, the image expansion part 704 transfers the expanded content to the compression error calculating part 708.

The image display part 703 is display means which displays the image information expanded by the image expansion part 704 and an error correction image calculated by the compression error calculating part 708. The image display part 703 can be realized by, for example, a projector which projects an image onto the screen 3, a display device which itself displays an image, and the like.

The expanded image holding part 705 is data storing means which holds the image, which is obtained as a result of performing expansion processing of a compressed updated image transferred via the network N by the image expansion part 704, for a specified period. The expanded image holding part 705 includes a frame buffer of a size corresponding to the image size of the information transfer apparatus, and performs write processing to a corresponding region of the frame buffer based on the image information from the information transfer apparatus.

The correction region determining part 706 is compression error correction region determining means which determines the region in which a compression error is corrected. The correction region determining part 706 determines an error correction region based on the correction region information included in the compression error image information transferred from the information transfer apparatus, for example.

The expanded image acquiring part 707 is expanded image information acquiring means which acquires image information of the corresponding region from the expanded image holding part 705 based on the error correction region about which it is instructed by the correction region determining part 706.

The compression error calculating part 708 is compression error correcting means which synthesizes the expanded image data which is acquired from the expanded image holding part 705 based on the region about which it is instructed by the correction region determining part 706, and the expanded image data of the compression error image. The compression error calculating part 708 has the function of synthesizing the image data of the expanded image holding part 705 and the image data of the compression error image, and outputting the synthesized image to the image display part 703.

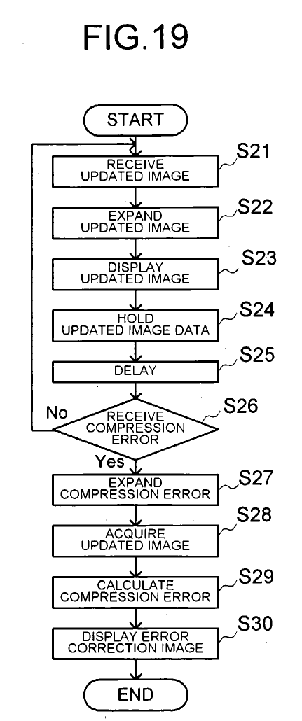

Next, an operation of the information receiving apparatus of this embodiment will be described with reference to FIG. 19. When receiving updated image information via the network N, the data receiving part 701 transfers the updated image information and compression error image information to the image expansion part 704, and transfers the correction region information included in the compression error image information to the correction region determining part 706 (S21).

When receiving the updated image information, the image expansion part 704 expands the updated image information by the expansion method corresponding to the compressed method (S22).

When the updated image information is expanded, the image expansion part 704 outputs the expanded image information to the image display part 703, and the image display part 703 projects/displays the image information (S23). The image expansion part 704 also writes the expanded image information into the frame buffer which is provided in the expanded image holding part 705 and has the size corresponding to the image size of the information transfer apparatus (S24). When the image information is displayed, the data receiving part 701 is in the reception waiting state (S25).

After a specified period elapses, the data receiving part 701 receives data (S26), and when the received compressed image information is updated image data again (Yes in S26), the image expansion part 704 expands the updated image information by the expansion method corresponding to the compressed method, and repeats processing from step 22 (S22).

When the compressed image information which the data receiving part 701 receives after a specified time elapses is error information (Yes in S26), the image expansion part 704 performs expansion processing of the received compression error information and transfers it to the compression error calculating part 708 (S27).

The correction region determining part 706 also receives correction region information included in the compression error image information from the data receiving part 701, determines the error correction region to be corrected, and instructs the expanded image acquiring part 707 about it. The expanded image acquiring part 707 reads the data of the error correction region of the image information held in the expanded image holding part 705 and transfers it to the compression error calculating part 708 (S28).

When receiving the data of the error region, the compression error calculating part 708 synthesizes the compression error information subjected to expansion processing by the image expansion part 704, and the transferred data of the error correction region (updated image information) and calculates a compression error, and generates an error correction image (S29).

When the error correction image is generated, the compression error calculating part 708 outputs the error correction image to the image display part 703, and the image display part 703 displays the error correction image (S30).

As described above, according to the information receiving apparatus of this embodiment, the error region of the display image is corrected based on the compression error information received at each predetermined interval, and therefore, the quality of the display image can be enhanced.

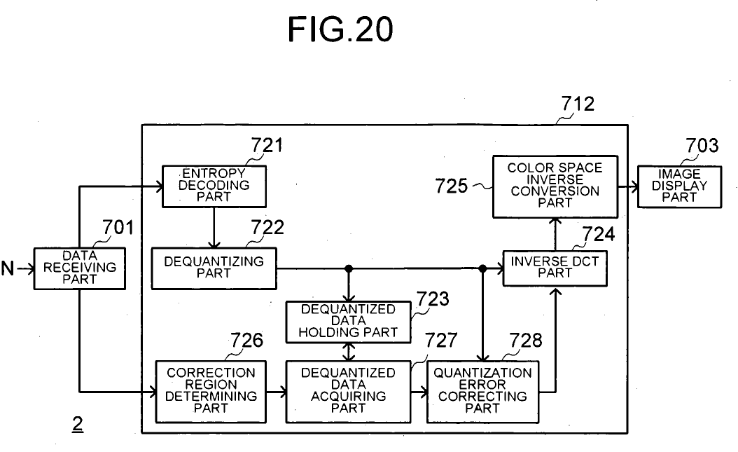

Subsequently, with reference to FIG. 20, an information receiving apparatus according to the eighth embodiment of the present invention will be described in detail. In the information receiving apparatus of this embodiment, the received data processing unit 702 of the information receiving apparatus of the seventh embodiment is replaced with a received data processing unit 712 shown in FIG. 20. Thus, the components common with those of the seventh embodiment are assigned with the common reference numerals and characters, and the redundant explanation will be omitted. In the received data processing unit 702 of the seventh embodiment, error correction is performed by holding the image data after expansion processing is finished, and the eighth embodiment differs from the seventh embodiment in the respect that in the received data processing unit 712 in FIG. 20, error correction is performed by holding the data after dequantization.

As shown in FIG. 20, the received data processing unit 712 of this embodiment includes an entropy decoding part 721, a dequantizing part 722, a dequantized data holding part 723, an inverse DCT part 724, a color space inverse conversion part 725, a correction region determining part 726, a dequantized data acquiring part 727 and a quantization error correcting part 728.

The entropy decoding part 721 is decoding means which entropy-decodes data transferred from the data receiving part 701. The entropy decoding part 721 corresponds to the entropy coding part 126 in the information transfer apparatus of the first embodiment, and uses a decoding method corresponding to the coding method of the entropy coding part 126.

The dequantizing part 722 is dequantizing means which dequantizes the data transferred from the entropy decoding part 721. The dequantizing means 722 corresponds to the quantizing part 124 in the information transfer apparatus of the first embodiment, and uses a dequantizing method corresponding to the quantizing method of the quantizing part 124. When the data to be processed is a compressed updated image, the dequantizing part 722 transfers the dequantized result to the dequantized data holding part 723 and the inverse DCT part 724. On the other hand, when the data to be processed is a compression error image, the dequantizing part 722 transfers the dequantized result to the quantization error correcting part 728.

The inverse DCT part 724 is transforming means which performs inverse DCT of the data transferred from the dequantizing part 722 or the quantization error correction part 728. The inverse DCT part 724 corresponds to the DCT part 122 of the first embodiment, and uses a transforming method corresponding to the transforming method of the DCT part 122.

The color space inverse conversion part 725 is converting means which performs color space inverse conversion of the data transferred from the inverse DCT part 724. The color space inverse conversion part 725 corresponds to the color space converting part 121 of the first embodiment, and uses a conversion method corresponding to the conversion method of the color space converting part 121. More specifically, the color space inverse conversion part 725 converts image data of the YCbCr color space into the image data of the RGB color space.

The correction region determining part 726 has the common configuration/function with the correction region determining part 706 of the seventh embodiment.

The dequantized data acquiring part 727 is data reading means which acquires data of the corresponding region from the dequantized data holding part 723 based on the error correction region about which it is instructed by the correction region determining part 726.

The quantization error correcting part 728 is quantization error correcting means which synthesizes dequantized data acquired from the dequantized data holding part 723 based on the error correction region about which it is instructed by the correction region determining part 726, and the dequantized data of the compression error image. The compression error correcting part 728 also has the function of synthesizing the image data of the dequantized data holding part 723 and the dequantized data of the compression error image, and outputting the obtained dequantized data to the inverse DCT part 724.

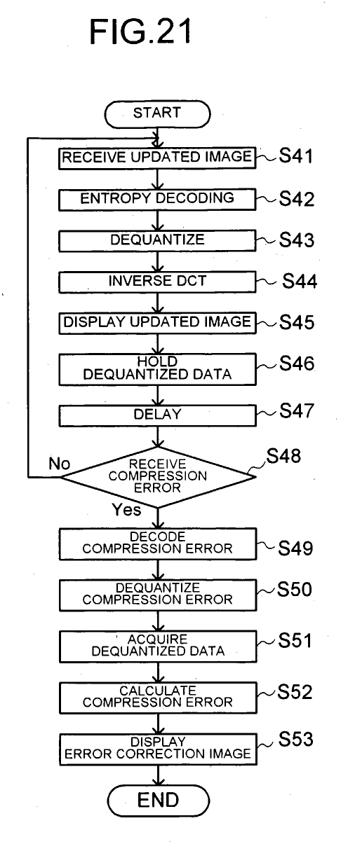

Subsequently, an operation of the information receiving apparatus of this embodiment will be described with reference to FIG. 21. When receiving updated image information via the network N, the data receiving part 701 transfers the updated image information and the compression error image information to the entropy decoding part 721, and transfers the correction region information included in the compression error image information to the correction region determining part 726 (S41).

When receiving the updated image information and the like, the entropy decoding part 721 entropy-decodes the received updated image information and the like, and transfers the obtained data to the dequantizing part 722 (S42).

When receiving the decoded data, the dequantizing part 722 dequantizes the received data and generates DCT coefficients (S43). When the DCT coefficients are generated, the dequantizing part 722 transfers the obtained DCT coefficients to the inverse DCT part 724.

The inverse DCT part 724 performs inverse DCT of the received DCT coefficients and generates image information of the YCbCr color space (S44).

When the image information is generated, the color space inverse conversion part 725 converts the image information into the image information of the RGB color space, and outputs it to the image display part 703. The image display part 703 projects/displays the received image information (S45).

Meanwhile, the dequantizing part 722 writes the generated DCT coefficients into the frame buffer which is provided in the dequantized data holding part 723 and is of the size corresponding to the image size of the information transfer apparatus (S46). When the image display part 703 displays the image information, the data receiving part 701 is in the reception waiting state (S47).

After a specified period elapses, the data receiving part 701 receives the data, and when the received compressed image information is updated image data again (No in S48), the entropy decoding part 721 decodes the data, the dequantizing part 722 dequantizes the received data and generates DCT coefficients, and the above described processing is repeated from then on.

When the compressed image information received by the data receiving part 701 after a specified time elapses is compression error image information (Yes of S48), the entropy decoding part 721 decodes the compression error image information (S49), and the dequantizing part 722 performs dequantization processing of the decoded compression error image information. The dequantized compression error image information is transferred to the dequantization error correcting part 728 (S50).

At the same time, the correction region determining part 726 receives correction region information among the compression error image information from the data receiving part 701, determines the error correction region to be corrected, and instructs the dequantized data acquiring part 727 about it. The dequantized data acquiring part 727 reads data of the error correction region of the dequantized data (DCT coefficients) held in the dequantized data holding part 723, and transfers it to the dequantization error correcting part 728 (S51).

When receiving the data of the error correction region, the quantization error correcting part 728 synthesizes the compression error image information subjected to dequantization processing by the dequantizing part 722 and the transferred data (updated image information) of the error region, calculates the compression error and generates the DCT coefficients corresponding to the error correction image (S52).

When generating the DCT coefficients corresponding to the error correction image, the quantization error correcting part 728 transfers the DCT coefficients of the error correction image to the inverse DCT part 724. The inverse DCT part 724 performs inverse DCT of the received DCT coefficients, and transfers the obtained image data to the color space inverse converting part 725. The color space inverse converting part 725 converts the image data of the YCbCr color space to the image data of the RGB color space, and outputs it to the image display part 703. The image display part 703 displays the error correction image (S53).

According to the information receiving apparatus of this embodiment, error information data is generated in accordance with dequantized data. Since in this case, a data amount used for error correction can be decreased depending on a down-sampling ratio used for compression, utilization of memory used in the dequantized data holding part 723 can be sometimes curtailed, and processing time can be expected to be shorter.

When there is a difference between an up-sampling filter used in the information transfer apparatus and an up-sampling filter used in the information receiving apparatus, if the data after up-sampling are synthesized, there is the possibility of occurrence of a new error due to the difference of the up-sampling filters. In this embodiment, an error is corrected before up-sampling, and therefore, increase in the error can be prevented.

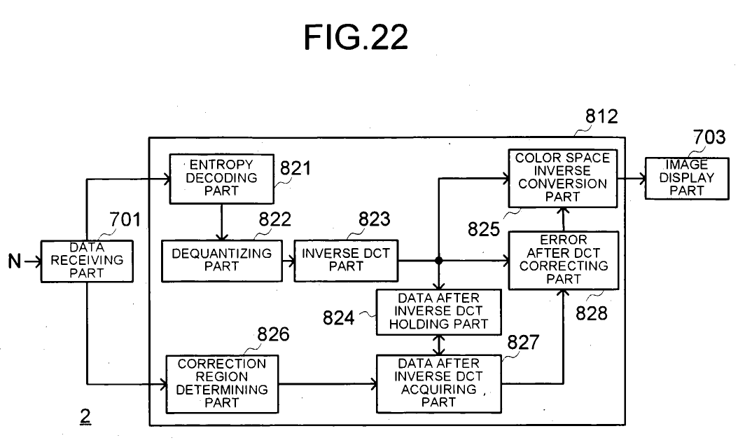

Subsequently, with reference to FIG. 22, an information receiving apparatus according to another embodiment of the present invention will be described in detail. In the information receiving apparatus of this embodiment, the received data processing units 702 and 712 of the information receiving apparatuses of the seventh and eighth embodiments are replaced with a received data processing unit 812 shown in FIG. 22. Thus, the components common with those of the seventh and eighth embodiments are assigned with the common reference numerals and characters, and the redundant explanation will be omitted. In the received data processing unit 702 of the seventh embodiment, error correction is performed by holding the image data after expansion processing is finished, and the ninth embodiment differs from the seventh embodiment in the respect that in the received data processing unit 812 in FIG. 22, error correction is performed by holding the data after inverse DCT.

As shown in FIG. 22, the received data processing unit 812 of this embodiment includes an entropy decoding part 821, a dequantizing part 822, an inverse DCT part 823, a data after inverse DCT holding part 824, a color space inverse converting part 825, a correction region determining part 826, a data after inverse DCT acquiring part 827 and an error after DCT correcting part 828. The entropy decoding part 821, the dequantizing part 822, the inverse DCT part 823, the color space inverse converting part 825, and the correction region determining part 826 respectively correspond to the entropy decoding part 721, the dequantizing part 722, the inverse DCT part 724, the color space inverse converting part 725, and the correction region determining part 726 in the eighth embodiment, and have the common constructions/functions.

The data after inverse DCT holding part 824 is data storing means which stores image data, which is subjected to inverse DCT by the inverse DCT part 823, for a specified period. The data after inverse DCT acquiring part 827 is data reading means which acquires data of the corresponding region from the data after inverse DCT holding part 824 based on the error correction region about which it is instructed by the correction region determining part 826.

The error after DCT correcting part 828 is error after DCT correcting means which synthesizes DCT coefficient data acquired from the data after inverse DCT holding part 824 based on the region about which it is instructed by the correction region determining part 826, and DCT coefficient data of the compression error image. The error after DCT correcting part 828 also has the function of synthesizing the DCT coefficients of the data after inverse DCT holding part 824 and the DCT coefficients of the compression error image, and outputting the obtained DCT coefficients (data after inverse DCT) to the color space inverse conversion part 825.

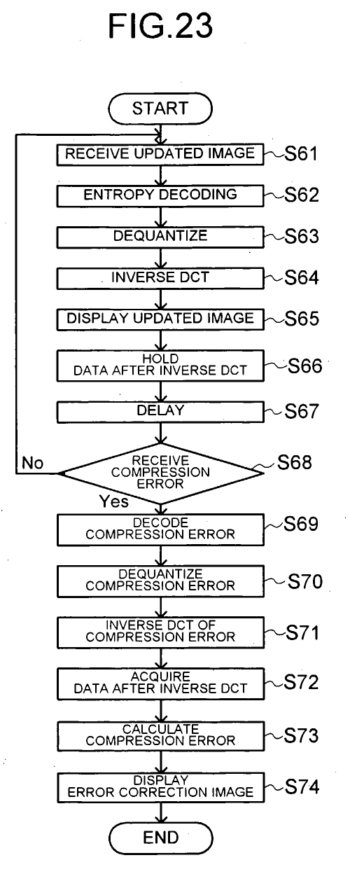

Subsequently, an operation of the information receiving apparatus of this embodiment will be described with reference to FIG. 23. When receiving updated image information via the network N, the data receiving part 701 transfers the updated image information to the entropy decoding part 821, and transfers the compression error image information to the correction region determining part 826 (S61).

When receiving the updated image information, the entropy decoding part 821 entropy-decodes the received updated image information, and transfers the obtained data to the dequantizing part 822 (S62).

When receiving the decoded data, the dequantizing part 822 dequantizes the received data and generates DCT coefficients. When the DCT coefficients are generated, the dequantizing part 822 transfers the obtained DCT coefficients to the inverse DCT part 823 (S63).

The inverse DCT part 823 performs inverse DCT of the received DCT coefficients and generates image information of the YCbCr color space (S64).

When the image information is generated, the color space inverse conversion part 825 converts the image information into the image information of the RGB color space, and outputs it to the image display part 703. The image display part 703 projects/displays the received image information (S65).

Meanwhile, the inverse DCT part 823 writes the generated image data into the frame buffer which is provided in the data after inverse DCT holding part 824 and is of the size corresponding to the image size of the information transfer apparatus (S66). When the image display part 703 displays the image information, the data receiving part 701 is in the reception waiting state (S67).

After a specified period elapses, the data receiving part 701 receives the data, and when the received compressed image information is updated image data again (No in S68), the entropy decoding part 821 decodes the data, the dequantizing part 822 dequantizes the received data and generates DCT coefficients, and the above described process is repeated from then on.

When the compressed image information received by the data receiving part 701 after a specified time elapses is compression error image information (Yes of S68), the entropy decoding part 821 decodes the compression error image information (S69), the dequantizing part 822 performs dequantization processing of the decoded compression error image information (S70), and the inverse DCT part 823 performs inverse DCT of the dequantized compression error image information. The converted compression error image information is transferred to the error after DCT correcting part 828 (S71).

At the same time, the correction region determining part 826 receives correction region information among the compression error image information from the data receiving part 701, determines the error correction region to be corrected, and instructs the data after inverse DCT acquiring part 827 about it. The data after inverse DCT acquiring part 827 reads data of the error correction region of the image data held in the data after DCT holding part 824, and transfers it to the error after DCT correcting part 828 (S72).

When receiving the data of the error correction region, the error after DCT correcting part 828 synthesizes the compression error correction information subjected to inverse DCT processing by the inverse DCT part 823 and the transferred data (updated image information) of the error region, calculates the compression error and generates an error correction image (S73).

When generating the error correction image, the color space inverse conversion part 825 converts the color space of the error correction image into the RGB color space from the YCbCr color space. The converted image data is transferred to the image display part 703. The image display part 703 displays the error correction image (S74).

According to the information receiving apparatus of this embodiment, when implementation of DCT differs between the information transfer apparatus and information receiving apparatus, a rounding error and the like can be excluded.

The present invention is not limited to the above described embodiments. In the above described explanation, the information transfer apparatuses and the information receiving apparatuses of the embodiments according to the present invention are described, but the present invention is not limited to them. Namely, it is possible to construct the information transfer apparatus and information receiving apparatus as a projector system by properly combining the information transfer apparatuses according to the first to sixth embodiments, and the information receiving apparatuses according to the seventh to the ninth embodiments. The components may be modified and embodied in the scope without departing from the spirit of the present invention. For example, several components may be deleted from all the components shown in each of the above described embodiments.

Further, in the information transfer apparatuses according to the above described first to sixth embodiments, while the screen information of the information receiving apparatuses is transferred, the configurations of the image compressing units 114 to 614 of the information transfer apparatuses which are the first to sixth embodiments may be properly changed. Similarly, the configurations of the received data processing units 702, 712 and 812 of the information receiving apparatuses which are the seventh to the ninth embodiments may be properly changed. Here, change of the configurations of the image compressing units 114 to 614 and change of the configurations of the received data processing units 702, 712 and 812 may be switched in accordance of preference of a user, or may be automatically switched when processing loads in the information transfer apparatuses and information receiving apparatuses are larger than predetermined load values.

Further, in the above described embodiments, the information transfer apparatuses and the information receiving apparatuses are described, but computer programs (software) which function as the information transfer apparatus and the information receiving apparatus by being installed into a computer may be adopted.

The software in the above described embodiments may be stored in a computer-readable storage medium such as a flexible disk, and may be transferred as single software (program). In this case, processing in each of the embodiments is made possible by a computer reading the software (program) stored in the storage medium, or downloading it from the site (server) on a local area network (LAN) and the Internet and installing it.

Namely, the software (program) in the present invention is not limited to those being stored in a storage medium independent from a computer, but includes those distributed through transmission media such as a LAN and the Internet.

As a storage media, any storage type may be suitable if only the storage medium can store the program and is a computer readable storage media, and examples of the storage medium include a magnetic disk, optical disks (CD-ROM, CD-R, DVD, etc.), a magnetic-optical disk (MO, etc.), a semiconductor memory and the like in addition to the above described flexible disk.

An OS (operating system) which operates on a computer, or MW (middleware) such as database management software and network software may be caused to execute a part of each processing for realizing the present embodiments based on the instruction of the program installed into the computer from a storage medium.

Further, the storage medium is not limited to a medium independent from the computer, but includes a storage medium storing or temporarily storing a program transferred from a LAN, the Internet or the like and downloaded from it. Further, the storage medium is not limited to one, but the recording media in the present invention includes a plurality of media from which the processing in the present embodiments is executed, and the medium configuration may be any configuration.

The computer executes each processing in the embodiments based on the program stored in the storage medium, and may have any configuration such as one apparatus constituted of a personal computer or the like, a system with a plurality of apparatuses connected by a network, or the like.

The computer is not limited to a personal computer, but includes a processor included in an information processing apparatus, a microcomputer and the like, and is a generic name for the apparatuses and devices capable of realizing the function of the present invention by a program.

According to the above described embodiments of the present invention, in the system of transferring information, reproducibility of quick screen updating and high image quality can be effectively realized with a low processing load.

1. An information transfer apparatus, comprising:
an image acquiring unit configured to output image information of a first region updated in a display screen;
a first image holding unit configured to hold the image information of the first region outputted from said image acquiring unit;
a data compressing unit configured to perform compression processing of the image information of the first region outputted from said image acquiring unit;
a second image holding unit configured to hold the image information of the first region compressed by said data compressing unit;
a region determining unit configured to determine a second region to be a transfer object of a compression error caused by said data compressing unit among the first region, based on output of said image acquiring unit;
a data expanding unit configured to extract and expand image information of the second region among the image information held by said second image holding unit;
an error calculating unit configured to generate error image information including the compression error based on the image information of the second region among the image information held by said first data holding unit, and the image information expanded by said data expanding unit; and
a transfer unit configured to transfer the image information subjected to the compression processing and the generated error image information to an outside.

2. An information transfer apparatus, comprising:
an image acquiring unit configured to output image information of a first region updated in a display screen;
an image holding unit configured to hold the image information of the first region outputted from said image acquiring unit;
a data compressing unit configured to perform compression processing of inputted image information and output it;
a region determining unit configured to determine a second region to be a transfer object of a compression error caused by said data compressing unit among the first region, based on output of said image acquiring unit;
an image extracting unit configured to extract and output image information of the second region among the image information held by said image holding unit;
a data expanding unit configured to expand the image information of the second region which is outputted from said image extracting unit and compressed by said data compressing unit;
an error calculating unit configured to generate error image information including the compression error based on the image information of the second region which is outputted from said image extracting unit, and the image information expanded by said data expanding unit; and
a transfer unit configured to transfer the image information subjected to the compression processing and the generated error image information to an outside.

3. The apparatus according to claim 1,
wherein said data compressing unit is further configured to perform compression processing of the error image information, and
wherein said transfer unit is further configured to transfer the error image information subjected to compression processing by said data compressing unit to the outside.

4. The apparatus according to claim 2,
wherein said data compressing unit is further configured to perform compression processing of the error image information, and
wherein said transfer unit is further configured to transfer the error image information subjected to compression processing by said data compressing unit to the outside.

5. An information transfer apparatus, comprising:
an image acquiring unit configured to output image information of a first region updated in a display screen;
an image holding unit configured to hold the image information of the first region which is acquired;
a first data compressing unit configured to compress the image information of the first region which is acquired;
a region determining unit configured to determine a second region to be a transfer object of a compression error caused by said data compressing unit among the first region, based on output of said image acquiring unit;
a second data compressing unit configured to compress image information of the determined second region among the image information held by said image holding unit;
an expanding unit configured to expand the image information of the second region which is compressed by said second data compressing unit;
an error calculating unit configured to generate error image information including the compression error based on the image information of the second region among the image information held by said data holding unit, and the image information expanded by said data expanding unit; and
a transfer unit configured to transfer updated image information including the image information after compression obtained from said first data compressing unit, and the error image information generated by said error calculating unit to an outside.

6. The apparatus according to any one of claims 1,
wherein said first image holding unit is configured to hold DCT coefficients of the first region as the image information of the first region.

7. The apparatus according to any one of claims 2,
wherein said image holding unit is configured to hold DCT coefficients of the first region as the image information of the first region.

8. The apparatus according to any one of claims 3,
wherein said first image holding unit is configured to hold DCT coefficients of the first region as the image information of the first region.

9. The apparatus according to any one of claims 4,
wherein said image holding unit is configured to hold DCT coefficients of the first region as the image information of the first region.

10. The apparatus according to any one of claims 5,
wherein said image holding unit is configured to hold DCT coefficients of the first region as the image information of the first region.

11. The apparatus according to claim 1,
wherein said second image holding unit is configured to hold quantized data of the first region as the image information of the first region which is compressed.

12. An information receiving apparatus, comprising:
a receiving unit configured to receive compressed image information of a first region in a display screen, and error image information of a second region including an error caused by the compression among the first region;
a data expanding unit configured to expand the received image information;
an expanded image holding unit configured to hold the expanded image information;
a region determining unit configured to determine the second region in which the error should be corrected of the image information held in said expanded image holding unit, based on the received error image information;
an error correcting unit configured to synthesize image information corresponding to the second region among the image information held by said expanded image holding unit, and the error image information, and generates an error correction image; and
an image display unit configured to display an image of the expanded image information and the generated error correction image on a screen.

13. A computer program which causes a computer to function as an information transfer apparatus, comprising:
an image acquiring unit configured to output image information of a first region updated in a display screen;
a first image holding unit configured to hold the image information of the first region outputted from said image acquiring unit;
a data compressing unit configured to perform compression processing of the image information of the first region outputted from said image acquiring unit;
a second image holding unit configured to hold the image information of the first region compressed by said data compressing unit;
a region determining unit configured to determine a second region to be a transfer object of a compression error caused by said data compressing part among the first region, based on output of said image acquiring unit;
a data expanding unit configured to extract and expand image information of the second region among the image information held by said second image holding unit;
an error calculating unit configured to generate error image information including a compression error based on the image information of the second region among the image information held by said first data holding unit, and the image information expanded by said data expanding unit; and
a transfer unit configured to transfer the image information subjected to the compression processing and the generated error image information to an outside.

14. A computer program which causes a computer to function as an information transfer apparatus, comprising:
an image acquiring unit configured to output image information of a first region updated in a display screen;
an image holding unit configured to hold the image information of the first region outputted from said image acquiring unit;
a data compressing unit configured to perform compression processing of inputted image information and outputs it;
a region determining unit configured to determine a second region to be a transfer object of a compression error caused by said data compressing unit among the first region, based on output of said image acquiring unit;
an image extracting unit configured to extract and output image information of the second region among the image information held by said image holding unit;
a data expanding unit configured to expand the image information of the second region which is outputted from said image extracting unit and compressed by said data compressing unit;
an error calculating unit configured to generate error image information including a compression error based on the image information of the second region which is outputted from said image extracting unit, and the image information expanded by said data expanding unit; and
a transfer unit configured to transfer the image information subjected to the compression processing and the generated error image information to an outside.
